(19) United States
(12) Patent Application Publication
(10) Pub. No.: US 2019/0179988 A1
(43) Pub. Date: Jun. 13, 2019

(54) SYSTEM AND METHOD FOR EMULATING HYBRID SYSTEMS

(71) Applicant: Auckland Uniservices Limited, Auckland (NZ)

(72) Inventors: Avinash Satyadeo Malik, Auckland (NZ); Parthasarathi Roop, Auckland (NZ)

(21) Appl. No.: 15/756,983

(22) PCT Filed: Sep. 2, 2016
(86) PCT No.: PCT/IB16/55257

§ 371 Date: Mar. 1, 2018

(30) Foreign Application Priority Data
Sep. 3, 2015 (NZ) 711839

(51) Int. Cl. G06F 17/50; G06F 9/448; G06F 9/455; G06F 17/13

(52) U.S. Cl. CPC G06F 17/5027; G06F 17/13; G06F 9/455; G06F 9/4498

(57) ABSTRACT

A method of generating code for deploying on a target emulation platform for the emulation of at least an aspect of a hybrid system. The method includes receiving, retrieving or generating input hybrid automata (HA) data indicative of one or more hybrid automata models representing at least an aspect of the hybrid system. The input hybrid automata (HA) data are processed to statically determine whether each hybrid automata model satisfies one or more predefined well-formedness criteria to qualify as well-formed hybrid automata (WHA) models. The method transforms the well-formed hybrid automata (WHA) models into corresponding respective synchronous hybrid automata (SHA) models, and generates emulation code for deployment onto a target emulation platform based on the synchronous hybrid automata (SHA) models so an aspect or aspects of the hybrid system can be emulated on the target emulation platform in a semantic preserving manner.

### CROSS-REFERENCE TO RELATED APPLICATIONS

This application is a US national phase of International Patent Application No. PCT/IB2016/055257, filed Sep. 2, 2016; which claims priority from New Zealand Patent Application No. 711839, filed Sep. 3, 2015, which applications are incorporated herein by reference in their entireties.

### TECHNICAL FIELD

The invention relates to a system and method for emulating hybrid or cyber-physical systems.

### BACKGROUND

Cyber-physical Systems (CPS) [1], [2] encompass a wide range of systems where distributed embedded controllers are used for controlling physical processes. Examples range from the controller of a robotic arm, controllers in automotive such as drive-by-wire applications to pacemakers for a heart. Such systems, also called hybrid systems, combine a set of discrete controllers with associated physical plants that exhibit continuous dynamics. An individual plant combined with its controller is often formally described using Hybrid Automata (HA) [2], [3], [4]. These HA use a combination of discrete locations or modes and Ordinary Differential Equations (ODEs) to capture the continuous dynamics of an individual mode.

CPS pose many key challenges for their design, especially since they are inherently safety-critical. CPS must operate in a sound manner while preserving key requirements for both functional and timing correctness [5]. Moreover, there is a need for most CPS to be certified using functional safety standards such as IEC 61580 [6] (robotics and automation), ISO 26262 [7] (automotive), DO-178B [8] (flight control), US Food and Drug Administration (FDA) [9] (medical devices). Certification is a key barrier to rapid adoption of new technology as compliance costs are prohibitive. Also, in spite of products being certified, faults can occur and associated recalls are required, which can be immensely costly in terms of human lives and economics. For example, close to 200,000 pacemakers were recalled between 1990-2000 due to software related failures and this trend is continuing [10].

In spite of these safety critical needs, current design practices often use tools without rigorous semantics. For example, simulation tools such as Matlab®, Simulink® or Stateflow® [11], [12] are arguably the default standard in many fields, including automotive and medical. These tools enable the encoding of a HA using a set of Simulink® blocks to specify the continuous dynamics while the discrete aspects are modelled using Stateflow®. Due to the lack of rigorous semantics in Simulink®/Stateflow®, many problems have been reported in literature regarding the lack of good model fidelity. For example, the Simulink®/Stateflow® simulation tool has many limitations, including:
Poor simulation fidelity due to the reliance on numerical solvers, which perform run-time backtracking. Also, changing the solver may result in different outcomes during simulation. Likewise, changes in the simulation step may have similar consequences.
Semantics of composition of the blocks in Simulink® is unclear and hence has consequences on simulation fidelity.
There is no direct correspondence between the HA model and the Simulink®/Stateflow® specification. Hence, it is very difficult to read and understand such specifications.
Simulink®/Stateflow® can generate code for emulation of a physical process (plant), but the generated code is both bulky and not effective for the real-time response needed for emulation.

To overcome the limitations associated with the Simulink®/Stateflow® simulation tool, tools with rigorous semantics such as Ptolemy [13] and Zélus [12],[14] have been developed. The Ptolemy and Zélus tools have developed mathematical semantics for the composition of the blocks and hence do not have semantic problems. However, these tools use numerical solvers during simulation to solve the ODEs. This poses two key challenges in the design of the CPS. Firstly, the simulation is inherently slow and potentially unsuitable for validating controllers in closed loop, which can be critical to certification. Secondly, simulation fidelity is dependent on the nature of the ODE solver and changing the solver may result in a different outcome. The Ptolemy and Zélus tools are discussed further below.

Hardware-in-the loop simulation, also known as emulation [15], uses the actual plant in conjunction with the controller for validation. Emulation has been shown in many domains (such as motor controllers) to be an extremely effective method of validation. However, emulation of a hybrid system may not be feasible due to the following reasons. Firstly, the physical process may also be part of the design and not available for testing, e.g. a robotic arm and its controller are required but the actual robot may not exist yet. This is an even more significant hurdle for medical devices such as pacemakers, where emulating the actual system is often not feasible or may require animal experiments that are challenging in terms of ethics, time and cost. Secondly, simulation of physical process using existing tools may not be able to meet the timing requirements of emulation, e.g. real time responses.

The design of CPS requires both formal analysis [17] and testing-based validation. Of particular importance is the need for emulation-based validation [15], as outlined above. Hybrid automata and their compositions [3],[4] provide a formal framework for the specification of hybrid systems. There are well known negative results on the decidability of the reach-ability problem over hybrid automata, i.e., even the simplest class, called linear hybrid automata, is undecidable [3]. Several restrictions have been proposed with associated semi-decidable results that are used for developing model checking-based solutions [18]. However, the negative decidability results mean that both formal analysis and modular code generation are critical [12].

Conventional CPS design relies on commercial tools such as Simulink® or Stateflow® [11]. However, Simulink® and Stateflow® lack formal semantics for the composition of the components leading to issues with simulation fidelity (see [12], [19] for details). In contrast to commercial tools, academic variants such as Ptolemy [13] and Zélus [12] are founded on formal models of computation. Ptolemy supports multiple models of computations and a specification can seamlessly combine them. This approach is extremely powerful for the simulation of complex CPS. These tools can model hybrid systems that use numerical solvers. However, there is no support for designing HA.

Sequential code generation from synchronous specifications is known [16], [20], For example, the code generator from SCADE specifications [21], [22] generates certified code according to the DO-178B standard. However, existing synchronous code generators are designed for discrete systems only and unsuitable for generating code from HA descriptions. Zélus [12], on the other hand, is an extension of the synchronous language Lustre [16] with ODEs for the design of hybrid systems. Zélus [12] overcomes the semantic ambiguities associated with Simulink®. While Ptolemy [13] and Zélus [12] are significant developments for CPS design due to their sound semantics, they are limited by their reliance on dynamic ODE solvers during simulation. Consequently, they are unsuitable for the emulation of physical processes, as explained further below.

Ptolemy is a tool chain for cyber-physical systems and supports multiple models of computation (MoC) [13]. The tool is founded on mathematical semantics and hence robust. However, it also has several limitations when considering HA models and emulation. Firstly, like the Simulink®/Stateflow® simulation tool there is no direct way to capture HA descriptions and HA has to be encoded using other directors (MoCs). Ptolemy relies on dynamic interaction with numerical solvers and hence suffers from their inefficiencies. Hence, Ptolemy is not suitable for emulation.

The Zélus tool extends the synchronous language SCADE with ordinary differential equations (ODEs) [14]. Unlike Simulink®, this tool defines precise mathematical semantics based on the synchronous approach [16]. While the Zélus tool is better compared to Simulink®/Stateflow® for simulation, it has the following limitations for emulation. It relies on zero crossing detection for the interaction between the synchronous program and an external ODE solver. One major limitation is that if zero crossings happen faster than the tick (duration of the synchronous instant), the synchrony hypothesis will be broken and hence the tool chain will not be usable in such scenarios. As the tool relies on an external ODE solver and zero crossing detection, the limitations of the ODE solver are indirectly inherent in the developed approach. While the Zélus tool is good for simulation, it is not able to provide the real-time response needed for emulation.

Code generation without using numerical solvers have been attempted in the past with limited success. Alur et al. generated code from statechart-like hierarchical HA models [23] by proposing a requirement of restricting HA execution to what was statically verifiable. The proposal required that the HA models must be non-deterministic in nature and enforced the very restrictive requirement that “a given mode and the corresponding guard of any switch must overlap for a duration that is greater than the sampling period” [23]. In a similar vein, Kim et al. also presented an approach for modular code generation from HA [24] based on the discretization of HA by restrictively requiring that “transitions are taken at time multiples of the discretization step” such that the time spent in any location must be exactly divisible by the discretization step. Also, a SystemC based code generation for HA has been proposed [25]. However, the actual algorithms proposed are restricted to timed automata and hence unsuitable for the general class of HA. These code generators are not adequate for modelling physical plant properties in many examples, including a large class of real-world processes.

In this specification where reference has been made to patent specifications, other external documents, or other sources of information, this is generally for the purpose of providing a context for discussing the features of example embodiments. Unless specifically stated otherwise, reference to such external documents is not to be construed as an admission that such documents, or such sources of information, in any jurisdiction, are prior art, or form part of the common general knowledge in the art.

### BRIEF DESCRIPTION OF THE DRAWINGS

Embodiments of the invention will be described by way of example only and with reference to the drawings, in which: FIG. 1A is a flow diagram depicting the main steps of the system and method for emulating hybrid systems in accordance with example embodiments.

FIG. 1B is a schematic diagram of a code generation system in accordance with an example embodiments.

FIG. 1C is a schematic diagram of an example configuration for testing or verifying a controller for a plant being emulated on a target emulation platform based on code generated by the code generation system in accordance with example embodiments.

FIG. 2A is a schematic diagram of a water tank system comprising a water tank and gas burner to which an embodiment of the emulation system and method will be applied by way of working example.

FIG. 2B is a trace of temperature versus time of the water tank system of FIG. 2A generated by a component of the emulation system and method in accordance with an example embodiment.

FIG. 2C is a schematic diagram of the hybrid automata representing the water tank of the water tank system of FIG. 2A.

FIG. 2D is a schematic diagram of the hybrid automata representing the gas burner of the water tank system of FIG. 2A, in which the reaction time of the gas burner is 1/10 seconds.

FIG. 3 is a visual representation of an example of the synchronous approximation generated by a Synchronous Hybrid Automata (SHA) corresponding to a Well-formed Hybrid Automata (WHA) in accordance with an example embodiment of the emulation system and method.

FIG. 4 is a flow diagram depicting the main steps of the emulation system and method for compiling or generating code for a single Hybrid Automata (HA) in accordance with an example embodiment.

FIG. 5A is the schematic diagram of the HA (see Definition 1 for example) of the water tank of FIG. 2C in which symbols K and h are constants with values 0.075 and 150 respectively.

FIG. 5B is a schematic diagram of an SHA (see Definition 5 for example) generated from the WHA of FIG. 5A in accordance with an embodiment of the emulation system and method, and in which the flow predicates are described using witness functions, values of the constants K and h are constants with values 0.075 and 150 respectively, and witness function F₁=C₁e^{-0.075×l}+150.0 and F₂=C₁e^{-0.075×l}.

FIG. 5C is a schematic diagram of a Synchronous Witness Automata (SWA) that represents the back-end code generated from the SHA of FIG. 5B, and in which the notation x[k] is used to update the value of x, although x[k] represents the valuation of the continuous variable x, and where the physical time t=k×δ, and where k is the logical tick and δ is the tick length.

FIG. 6A is a schematic diagram of an example HA in a case 1 where there is an increasing function and it does not need saturation.

FIG. 6B is a schematic diagram of an example HA in a case 2 where due to equality there is a need for saturation.

FIG. 6C is a schematic diagram of an example HA in a case 3 where there is a decreasing function and it does not need saturation.

FIG. 6D is a graph of the value of the variables versus time for each of the example HA cases in FIGS. 6A-6C, with the behaviors of the example HAs depicted in solid lines, and the synchronous approximations generated by an embodiment of the emulation system and method being depicted using dashed lines, and in which each tick is one second long.

FIG. 7A is a schematic diagram of partial HAs of the water tank (top) and gas burner (bottom) of FIG. 2A.

FIG. 7B is a schematic diagram of the equivalent partial SHAs of the water tank (top) and gas burner (bottom) corresponding to the partial HAs in FIG. 7A.

FIG. 7C is a schematic diagram of the SWAs of the water tank (top) and gas burner (bottom) corresponding to the partial SHAs of FIG. 7B.

FIG. 7D is a schematic diagram of a parallel composition of the SWAs of the water tank and gas burner of FIG. 7C as a single SWA.

FIG. 8A is a graph depicting the execution time comparing code generated by a Simulink® system to code generated by an embodiment of the emulation system and method across various benchmarks described in Table 3.

FIG. 8B is a graph depicting the code size comparing code generated by a Simulink® system to code generated by an embodiment of the emulation system and method across various benchmarks described in Table 3.

### DETAILED DESCRIPTION

Example embodiments provide an emulation method and system and technique that is capable of generating code from hybrid automata representing a cyber-physical system, such as a hybrid system, that can be deployed on a target platform to emulate the hybrid system in a semantic preserving manner, or to at least provide the public with a useful choice.

In a first aspect, example embodiments broadly consist of a method of generating code for deploying on a target emulation platform for the emulation of at least an aspect of a hybrid system, the method executed on a processor having associated memory, and comprising: receiving, retrieving or generating input hybrid automata (HA) data indicative of one or more hybrid automata models representing at least an aspect of the hybrid system; processing the input hybrid automata (HA) data to statically determine whether each hybrid automata model satisfies one or more predefined well-formedness criteria to qualify as well-formed hybrid automata (WHA) models, the well-formedness criteria at least requiring that any ordinary differential equations (ODEs) defining each hybrid automata model be closed-form in nature such that they are analytically or symbolically solvable; transforming the well-formed hybrid automata (WHA) models into corresponding respective synchronous hybrid automata (SHA) models, where the synchronous hybrid automata models are an under-approximation of their well-formed hybrid automata (WHA) where any ordinary differential equations are replaced with their corresponding witness function representing the closed-form solution of the ordinary differential equation; and generating emulation code for deployment onto a target emulation platform based on the synchronous hybrid automata (SHA) models so an aspect or aspects of the hybrid system can be emulated on the target emulation platform in a semantic preserving manner.

In an embodiment, the input hybrid automata data corresponds to one or more hybrid automata models representing an aspect or aspects of a physical process or plant of the hybrid system.

In an embodiment, the input hybrid automata data corresponds to one or more hybrid automata models representing an aspect or aspects of the controller and the physical process and/or plant of the hybrid system.

In an embodiment, the input hybrid automata data corresponds to a network of hybrid automata models representing an aspect of the controller and/or physical process and/or plant.

In an embodiment, the input hybrid automata data correspond to hybrid input/output automata models representing an aspect or aspects of the physical process or plant of the hybrid system.

In an embodiment, the well-formedness criteria further requires that all solutions (witness functions) to the ordinary differential equations (ODEs) are monotonic.

In an embodiment, the well-formedness criteria define witness functions of ordinary differential equations (ODEs) to be monotonic if the first derivative of the witness function does not change sign.

In an embodiment, the well-formedness criteria further requires that all invariants, jump and initial predicates are constrained or bounded by natural or rational numbers.

In an embodiment, processing each hybrid automata model to determine if the ODEs are closed-form in nature comprises sequentially processing the ODEs at each location in the hybrid automata model to determine whether each is analytically or symbolically solvable.

In an embodiment, the method further comprises generating an error signal or message if any of the hybrid automata models represented by the input hybrid automata do not satisfy the well-formedness criteria.

In an embodiment, the synchronous hybrid automata (SHA) models represent an under-approximation of their corresponding well-formed hybrid automata (WHA) models in that the valuation of continuous variables in the SHA models is made at discrete valuation instants and the values of the continuous variables remain constant between two adjacent distinct valuation instants.

In an embodiment, generating emulation code for deployment onto a target emulation platform based on the synchronous hybrid automata (SHA) models comprises transforming each SHA model into a corresponding respective synchronous witness automata (SWA) that represents the behavior of the SHA model as a synchronous state machine, and generating the emulation code based on the individual SWA models.

In an embodiment, generating the emulation code based on the individual SWA models comprises linking the of the SWA modules by parallel composition of the SWA models into a single SWA model from which the emulation code is derived.

In an embodiment, the parallel composition is applied recursively.

In an embodiment, the emulation code based on the individual SWA models comprises generating modular code representing each respective SWA model and linking the modular code to generate the emulation code.

In an embodiment, transforming the well-formed hybrid automata (WHA) models into corresponding respective synchronous hybrid automata (SHA) models comprises generating each SHA such that is executes in code as a Discrete Time Transition System (DTTS) such that all transitions trigger relative to the ticks of a logical clock associated with the generated code.

In an embodiment, the method further comprises configuring the emulation code to dynamically saturate continuous variables to a saturation value when switching states or locations if the continuous variable does not satisfy a guard condition.

In an embodiment, the emulation code is in the form of any of the following: software code such as C code, a hardware description language such as VHDL code, or data defining a finite state machine.

In an embodiment, the method further comprises converting or compiling the emulation code into an executable or binary file for deploying and executing on the target emulation platform.

In an embodiment, the target emulation platform may comprise any one or more of the following: a processor, FPGA, or ASIC.

In a second aspect, example embodiments broadly consist of a method of generating code for deploying on a target emulation platform for the emulation of at least an aspect of a hybrid system, the method executed on a processor having associated memory, comprising generating emulation code representing an aspect or aspects of the hybrid system based only on input hybrid automata that are verified as being analytically or symbolically solvable.

In a third aspect, example embodiments broadly consist of a method of generating code for deploying on a target emulation platform for the emulation of at least an aspect of a hybrid system, the method executed on a processor having associated memory, comprising: receiving, retrieving or generating input hybrid automata (HA) data indicative of one or more hybrid automata models representing at least an aspect of the hybrid system; verifying if the hybrid automata models are well-formed; generating modular code representing each verified well-formed hybrid automata model; linking the modular code to generate emulation code representing the aspect or aspects of the hybrid system for execution on a target emulation platform.

In a fourth aspect, the example embodiments broadly consist of a code generation system for generating emulation code for deploying on a target emulation platform for the emulation of at least an aspect of a hybrid system comprising: an input interface that is operable or configured to receive, retrieve or generate input hybrid automata (HA) data indicative of one or more hybrid automata models representing at least an aspect of the hybrid system; a processor configured to carry out the method of any one of the first-third aspects; and an output interface for outputting the generated emulation code.

In a fifth aspect, example embodiments broadly consist of an emulation system for testing or validating a controller of a hybrid system comprising: a controller; an emulation platform operatively connected to or in data communication with the controller, the emulation platform executing emulation code generated by the method of any one of the first-third aspects that represents an aspect or aspects of the hybrid system.

In an embodiment, the emulation code represents a physical process or plant of the hybrid system.

In a sixth aspect, example embodiments broadly consist of a computer-readable medium having stored thereon computer executable instructions that, when executed on a processing device or devices, cause the processing device or devices to perform a method of any one of the first-third aspects.

In a seventh aspect, example embodiments broadly consist of an emulation platform configured with or executing emulation code generated by the method of any one of the first-third aspects such that the emulation platform can emulate an aspect or aspects of a hybrid system.

In an eighth aspect, example embodiments broadly consist of a computer-readable medium having stored thereon computer executable instructions representing the emulation code generated by the method of any one of the first-third aspects, the computer executable instructions when executed on a processing device causing the processing device to emulate an aspect or aspects of a hybrid system.

Each aspect of the example embodiments above may have any one or more features mentioned in respect of the other aspects.

### Definitions or Terms or Phrases.

The phrase “target emulation platform” as used in this specification and claims is intended to mean, unless the context suggests otherwise, any programmable device or system or any electronic device and system that is capable of executing code, including, but not limited to, a device or system comprising a processor, Application Specific Integrated Circuit (ASIC), Field Programmable Gate Array (FPGA), or a processor, ASIC, FPGA itself, or any integrated circuit that is configurable to execute programmable logic.

The term “plant” as used in this specification and claims is intended to mean, unless the context suggests otherwise, the physical process or aspects of a cyber-physical system, such as a hybrid system, that are separate to the controller or controllers.

The phrase “computer-readable medium” as used in this specification and claims should be taken to include a single medium or multiple media. Examples of multiple media include a centralised or distributed database and/or associated caches. These multiple media store the one or more sets of computer executable instructions. The phrase “computer readable medium” should also be taken to include any medium that is capable of storing, encoding or carrying a set of instructions for execution by a processor of the mobile computing device and that cause the processor to perform any one or more of the methods described herein. The computer-readable medium is also capable of storing, encoding or carrying data structures used by or associated with these sets of instructions. The term ‘computer-readable medium’ includes solid-state memories, optical media and magnetic media.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

### Number Ranges

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

### 1. Overview

The majority of interesting systems to be designed are hybrid in nature, i.e. they constitute a discrete controller that is used for controlling a physical process (plant) exhibiting continuous dynamics. Examples include smart grid applications, medical devices, manufacturing processes, and intelligent transportation systems. As mentioned, hybrid automata (HA) [4] are a well known and widely used formal model for the specification of such systems. While many approaches exist for simulation of hybrid automata, there is no known approach for automatic code generation from hybrid automata that ensures model fidelity.

Example embodiments to a system and method for automatically generating code based on hybrid automata (HA) for emulating hybrid systems. For example, the emulation system and method enables the implementation of an aspect or aspects of a hybrid system in code that is deployable for execution onto a target platform such as, but not limited to, a programmable hardware device system comprising such as or comprising a processor, Application Specific Integrated Circuit (ASIC), or Field Programmable Gate Array (FPGA), or similar. The code generated, directly or indirectly, by the emulation system and method may be in any suitable software or hardware language such as, but not limited to, C or VHDL, for example. In one example, the emulation system and method generates an implementation of the hybrid system in C, and subsequently VHDL. In an embodiment, the emulation system and method enables the design of plant-on-a-chip (PoC), which can be used for emulation of the plant of a hybrid system to enable the testing and/or validation of discrete controllers. A PoC is an implementation of a hybrid system in C (and subsequently VHDL), so that a physical process (e.g. plant) can be emulated using an embedded system or hardware device such as or comprising a processor, ASIC, or FPGA. The hardware device can then be used for closed-loop validation of controllers in wide ranging applications in Cyber-physical Systems (CPS) and provides for emulation of physical plants in diverse domains such as, but not limited to, robotics, automotive, and medical devices, and intelligent transportation systems. The approach is mathematically sound and avoids the need for dynamic interaction with numerical solvers.

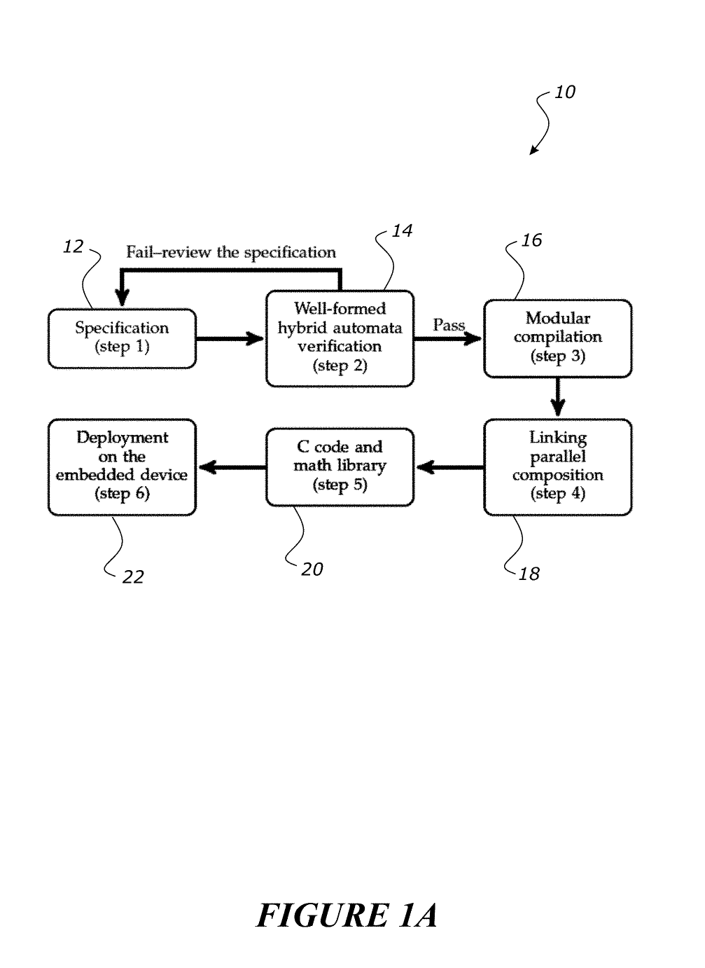

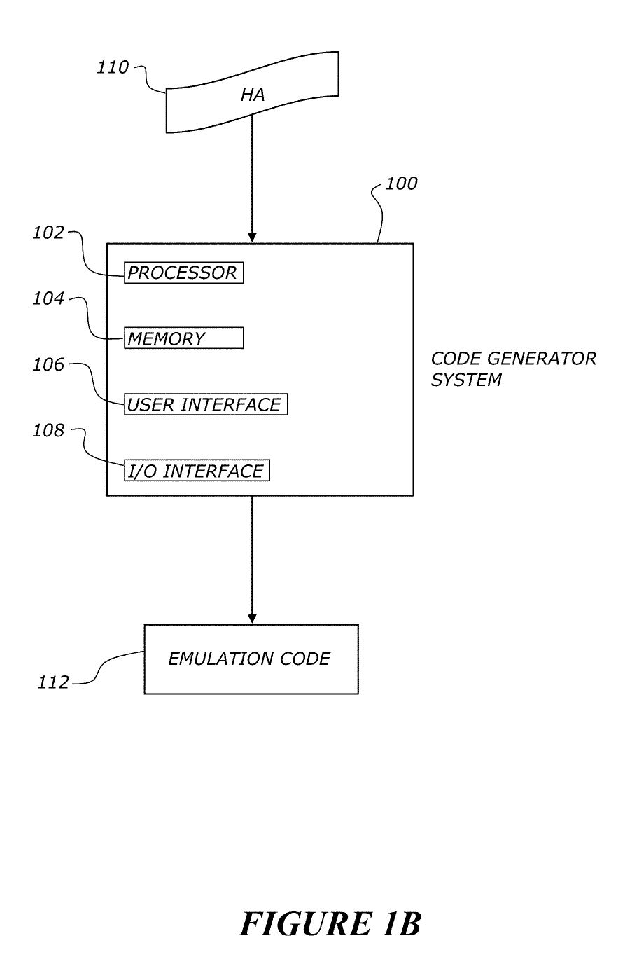

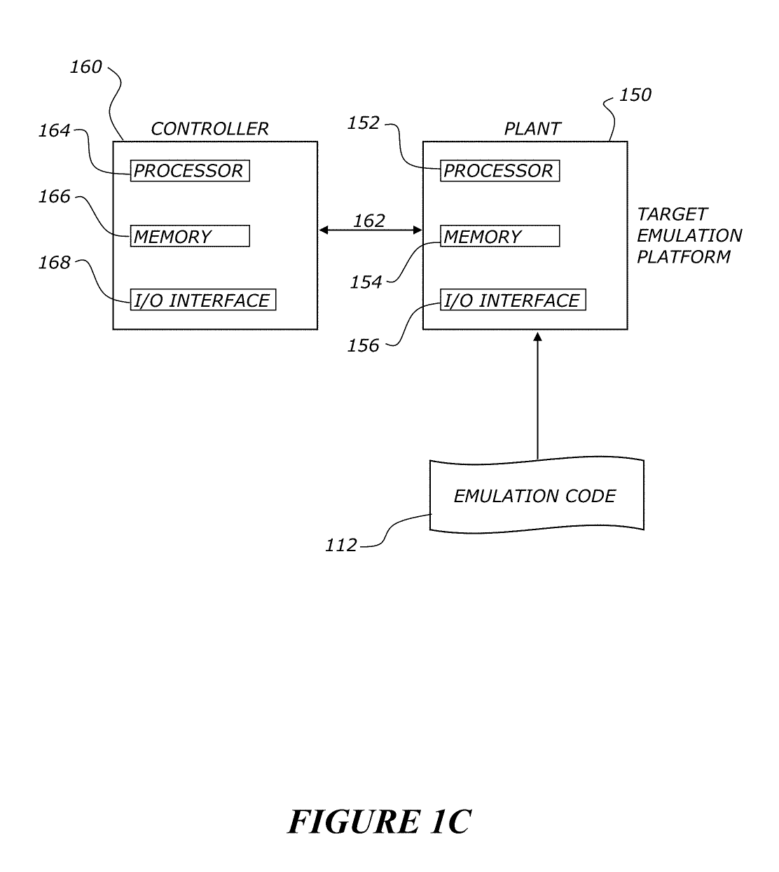

Referring to FIG. 1A, an overview 10 of the code generation methodology implemented by the emulation method and system is depicted. Firstly, a specification or input data that describes an HA model or a network of HA models of a hybrid system is received, retrieved or defined, as shown at the input or starting step 12. The input HA model data may represent, define or describe the entire physical process (e.g. plant) of the hybrid system, or a part or parts of the physical process. Following this, a verification step 14 is undertaken to facilitate code generation. In the verification step 14, the HA model or models are constrained or restricted using at least one or a set of well-formedness criteria, which can be statically verified. If the HA model or models satisfy the criteria, they are considered Well-formed Hybrid Automata (WHA) models which are amenable to code generation. Once the verification of the HA models as WHA models succeeds, the method is then configured to introduce an abstraction called Synchronous Hybrid Automata (SHA), that provides the semantics of the generated code, and using this abstraction separate transformation and compilation can be performed for each WHA as shown at the modular compilation step 16. Such modular compilation is feasible due to the synchronous semantics of a network of well-formed HAs (WHAs) discussed in Section 3.4 below. Using these semantics, a linking operation step 18 of the generated code, such as C code for example, is performed. Lastly, the generated code representing the physical process of the hybrid system, such as C code, is compiled at compiling step 20, for example using a standard C compiler if it is C code, and then a deployment step 22 is used to deploy or load corresponding binary code or to otherwise program an embedded target platform, such as or comprising a processor, ASIC, or FPGA to emulate the coded hybrid system by executing the generated code. Each of the steps is further detailed, by way of example, in section 4 below in accordance with an embodiment of the emulation system and method.

Referring to FIG. 1B, an example hardware configuration for the code generation system 100 of the emulation system and method is shown. The code generation system 100 may be performed on any programmable electronic device that is configured to execute the code generation methodology. In this embodiment, the code generation system may be implemented on a computing system comprising a processor 102, memory 104, user interface 106, and input/output interface 108. In one configuration, the code generation system is configured to receive input data indicative of the hybrid automata (HA) defining the plant or aspects of the plant of the hybrid system to be emulated. The HA input data may be in any suitable computer-readable form for defining an HA model or description. The processor 100 is configured to execute code generation software that processes the input HA model or models in accordance with the process steps overviewed with reference to FIG. 1A, and generate output emulation code 112 representing the HA for execution on a target emulation platform. The output emulation code 112 may be in the form of C code or a hardware language, such as VHDL for example, and may be either directly loaded or deployed onto the target emulation platform, or further transformed into a form suitable for loading or executing on the emulation platform. It will be appreciated that the output emulation code 112 may be stored in memory 104 on the code generation system, stored on an associated storage device or medium, such as a hard drive, or stored in an associated database.

Referring to FIG. 1C, an example configuration 200 for testing a controller for a hybrid system based on the emulation system and method will be described. The emulation code 112 generated by the code generation system described in FIG. 1B is a loaded or deployed onto a target emulation platform 150, which may be a processor, ASIC or FPGA for example, which represents the PoC. In some examples, the target emulation platform may comprise a processor typically having memory 154 and an input/output interface 156 that is either internal or external to the processor, depending on the emulation platform or system. In the configuration shown, the processor is loaded with emulation code 112 and is configured to execute the code to emulate the HA representing the plant or aspects of the plant of the hybrid system. In the embodiment shown, the target platform is operatively connected to a controller 160, for example over a wired or wireless link or otherwise communicatively coupled over a data link 162. The controller 160 may be tested or verified by controlling the emulated plant on the target platform 150 via control signals over the data or communication link 162. The target platform 150 receives the input control signals and generates output signals representing operation of the plant as feedback to the controller. The controller 160 may be operating on any suitable programmable hardware device or system, and typically comprises a processor 164, memory 166, and input/output interface 168. In one configuration the controller may be software operating on a personal computer. In another configuration, the controller may be an embedded device or system, or a standalone controller device. In another configuration, the controller may be integrated with or implemented on the target emulation platform 150, such that the controller being tested or verified is operating on the same platform as the emulated plant. For example, if the target platform comprises a multicore processor, one softcore processor could be configured to emulate the plant and the other could execute the controller code, such that they execute in parallel. Alternatively a single processor could be configured with a scheduler to operate the controller and plant sequentially or alternately.

An embodiment of the emulation system and method with reference to an application of the system to an example hybrid system in the form of a water tank system, although it will be appreciated the concepts and principles of the system and method may be applied to any other suitable CPS or hybrid system. Section 2 describes HA as a modelling framework for CPS. The concept of a well-formed HA (WHA) as a restrictive class that is amenable for code generation is also described. Section 3 describes an abstraction of WI-IA called Synchronous Hybrid Automata (SHA) and presents its semantics. Section 4 describes the processes and/or algorithms for code generation based on the developed synchronous semantics. The algorithms include those to determine if an HA meets the requirements for code generation based on WHA. It also includes the back-end code generators from HA definitions to C using the developed synchronous semantics. In section 5 experimental data is presented comparing an embodiment of the emulation system and method with existing simulation tools such as Simulink®/Stateflow®.

### 2. Hybrid Automata

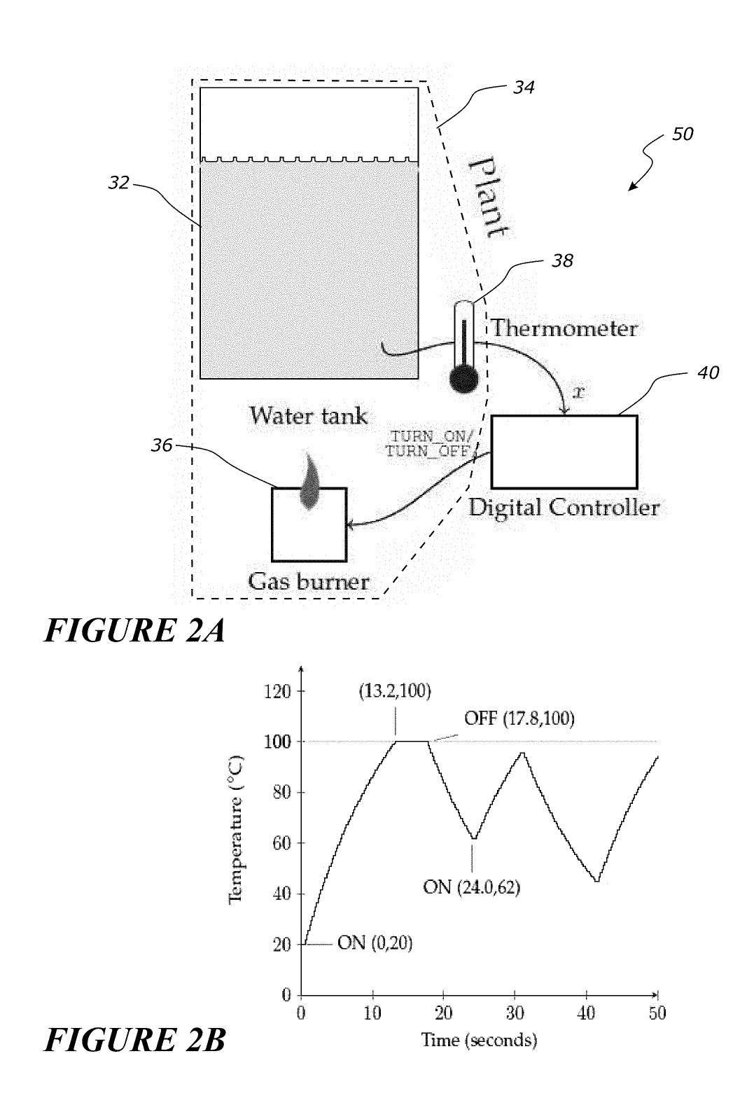

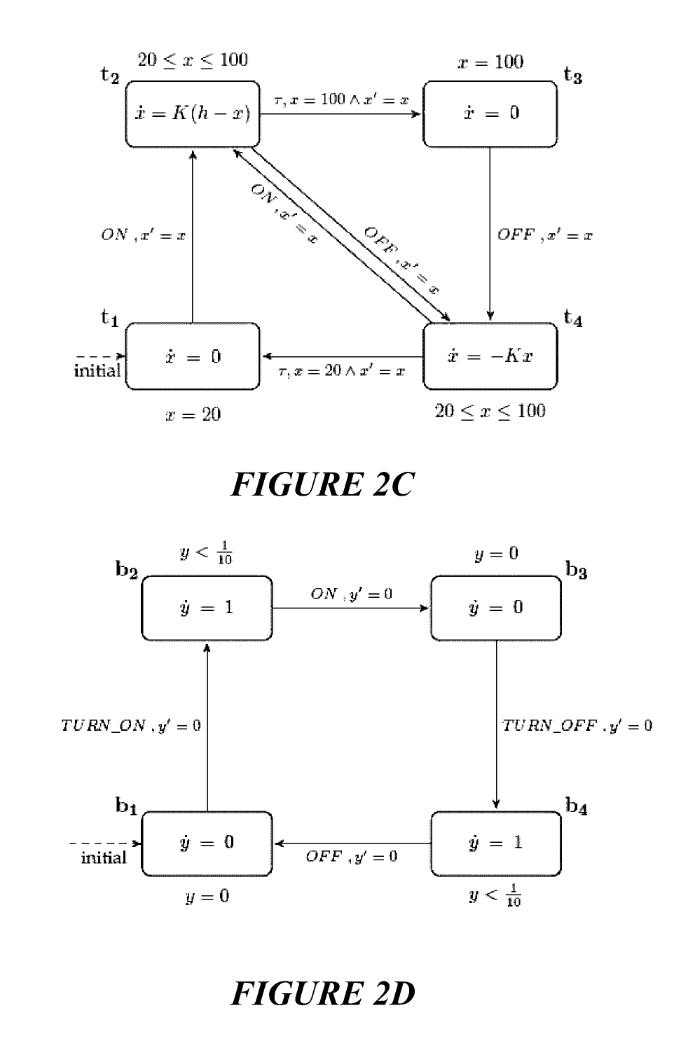

By way of example only, to illustrate the concept of hybrid automata (HA) a CPS or hybrid sysetm in the form of a water tank heating system 30 is presented in FIG. 2A (adapted from [3]), where the temperature of the water inside the water tank 32 is to be maintained between 20 and 100° C. The plant 34 in the water tank heating system 30 comprises the water tank 32, a gas burner 36 for heating the tank, and a thermometer 38 configured to sense the temperature in the tank and generate a representative temperature signal. The temperature is controlled by a digital controller 40 that switches the heating system ON and OFF at specific times so as to maintain the temperature of the water in the tank 32 within the required range. The temperature of water inside a tank is modelled using Newton's law of heating and cooling, which can be represented as x(t)=Ie^{-Kl}+h(1−e^{-Kl}). Here, I is the initial temperature, K is a constant that depends on the thermal conductivity of the tank, and h is a constant that depends on the power output of the heating system, such as the gas burner 36. An example trace of the temperature of water inside the tank for an initial temperature of 20° C. is shown in FIG. 2B. The initial temperature is 20° C. and the heating system is turned ON. Next, the temperature of water increases until it boils at 100° C., when the time instant is 13.2 seconds. Next, the temperature remains at 100° C. until 17.8 seconds, when the heating system is turned OFF by the controller. The temperature of water drops until 24.6 seconds, when the controller switches ON the heating system again. The hybrid automata representing the water tank 32 is shown in FIG. 2C and the hybrid automata representing the gas burner 36 is shown in FIG. 2D. In this example, the reaction time of the gas burner is 1/10 seconds.

In this embodiment, hybrid IO automata of Lynch et al. [28] are used to capture the behaviour of the hybrid system 30 similar to the models adopted by Chen et al. [27]. This approach is specifically amenable to the modelling of both the plant and its adjoining controller. The models will be referred to as as hybrid automata (HA) for convenience. It will be appreciated that other suitable hybrid automata models could be used in alternative embodiments.

The specification of the water tank 32 of the water tank heating system 30 using an HA is shown in FIG. 2C. An HA captures the interaction between the plant (exhibiting continuous dynamics) and a controller (making discrete mode switches). The continuous evolution of some real-valued variables is modelled using a set of ODEs, which specify the rate of change of these variables. The controller effects the discrete mode switches and in each mode the plant exhibits different dynamics. As a consequence, the ODEs in the different modes (also called locations) may be different. For the water tank 32, the HA can be in any one of four different locations t₁, t₂, t₃, and t₄, where t₁ is the initial location. The variable x is used to model the temperature of the water inside the tank. Each location has some flow predicates that specify the rate of change of the continuous variables. For example, in location t₂ the flow predicate that defines the rate of change of temperature when the heater is turned ON is specified as [symbol] =K(h−x). Invariants are associated with locations, e.g. 20≤x≤100 is an invariant associated with location t₂. Execution remains in a location until the invariant holds or an egress transition triggers prior to this. Some locations may have initialization conditions that provide the initial values of the variables i.e. location t₁. A transition out of a locations is enabled when the input (event) is present and the jump condition associated with the transition holds. When a given transition is taken, the final value of the variables are updated. For example, the transition from t₂ to t₃ is enabled when the value of temperature is 100° C. and as the transition is taken, the final value of x is updated using the equation x′=x, where x′ is an update variable. The values of the update variables are used as the initial values of the variables in the destination location.

An HA [28] is defined using Definition 1. For the water tank example shown in FIG. 2A, Loc={t₁, t₂, t₃, t₄}, Σ={ON, OFF, τ}, and an example edge in Edge is (t₁, ON, t₂). There is a single continuous variable x representing the temperature of the water in the tank. Hence, X={x}, [symbol] ={ [symbol] }, and X′={x′}. The only location that is marked initial is t₁ and Init(t₁):x=20. An example flow predicate is Flow(t₁): [symbol] =0, which specifies that the temperature of the water inside the tank does not change. A jump predicate assigned to an edge specifies the condition needed to take a transition and the updating of values of some continuous variables when the transition is taken. For example, Jump(t₄, τ, t₁):x=20̂x′=x specifies that the transition is taken when the value of the temperature is 20° C. and the updated value of the temperature is also 20° C. We now formalise the HA using Definition 1.

Definition 1 A hybrid automata is

H= [symbol] Loc, Edge, Σ, Inv, Flow, Jump [symbol] where
Loc={l₁, . . . , lₙ} representing n control modes or locations.
Edge⊆Loc×Σ×Loc are the set of edges between locations.
Σ=Σ₁∪Σ₀∪{τ} is set of event names comprising of input, output, and internal events.
Three sets for the set of continuous variables, their rate of change and their updated values represented as follows:

X={x₁, . . . , xₘ}, [symbol] ={ [symbol] ₁, . . . , [symbol] ₘ}, and

X′={x₁′, . . . , xₘ′}.
Init(l): Is a predicate whose free variables are from X. It specifies the possible valuations of these when the HA starts in l.
Inv(l): Is a predicate whose free variables are from X and it constrains these when the HA resides in l.
Flow(l): Is a predicate whose free variables are from X∪ [symbol] and it specifies the rate of change of these variables when the HA resides in l.
Jump(e): Is a function that assigns to the edge ‘e’ a predicate whose free variables are from X∪X′. This predicate specifies when the mode switch using ‘e’ is possible. It also specifies the updated values of the variables when this mode switch happens.

The semantics of an HA is specified using the notion of timed transitions systems (TTS) using Definition 2.

Definition 2 The semantics of an HA

H= [symbol] Loc, Edge, Σ, Inv, Flow, Jump [symbol] is defined by a timed transition system TTS= [symbol] [symbol] , [symbol] ₀, Σ, → [symbol]
[symbol] is of the form (l, v) where l is a location and v∈[X→R] such that v satisfies Inv(l). [symbol] is called the state-space of H.
[symbol] ₀⊆ [symbol] of the form (l, v) such that v satisfies Init(l).
→ is the set of transitions consisting of either:
   (1) Discrete transitions (instantaneous): For each edge e=(l, σ, l′). we have

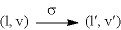

if (l, v)∈ [symbol] , (l′, v′)∈ [symbol] and (v, v′) satisfy Jump(e).
(2) Continuous transition (delay): For each non-negative real δ, we have

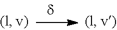

if (l, v)∈ [symbol] , (l, v′)∈ [symbol] , and there is a differentiable function ƒ:[0, δ]→R^{m} (which is a witness function of the above transition where m=|X|) with first derivative [symbol] :(0, δ)→R^{m} such that the following conditions hold:
ƒ(0)=v and ƒ(δ)=v′,
for all ε∈(0, δ), ƒ(ε) satisfies Inv(l) and (ƒ(ε), [symbol] (ε)) satisfies Flow(l).

The TTS semantics of an HA encodes the state-space [symbol] as all possible pairs of the form (l, v), where l is a location and v is a vector representing the valuation of the variables. In general, the state-space is infinite as there are infinite possible valuations of variables in between any time-step δ. Transitions may be any one of two types. A first type are discrete transitions that lead to a mode switch and these transitions are instantaneous. This happens when the input event is present, the guard condition is true and the updates are performed as the transition is taken. A second type are continuous transitions that capture the passage of time when control resides in a location.

### 3. Semantic Restrictions for Efficient Code Generation

The HA model introduced in the previous section is very generic, expressive, and hence powerful. However, it has limitations for code generation. Because it is desired to generate code for emulating physical processes, i.e., for PoC design, the efficient, real-time response of the generated code is critical.

Another limitation of generic HA must also be carefully considered for code generation. As discussed in the background, all known tools (including ones widely used in industry) solve ODEs at run-time using numeric techniques. Simulink® also introduces semantic ambiguities and there are problems with simulation fidelity, due to the dependence on the step size selected for the numerical solver [11]. For example, a numerical solver may fail to detect the peak of a continuous variable and may perform backtracking and other heuristic techniques, which affect the outcome of the simulation. As a consequence, robust tools, such as Ptolemy, are advocating the use of techniques such as quantized-state systems [29] as an alternative to dynamic numerical simulation.

In view of the above issues, this embodiment of the emulation system and method is configured with well-formedness criteria for admitting a sub-class of HA, which are herein called Well-formed Hybrid Automata (WHA), which are amenable to automatic code generation. In particular, the input HA defining a hybrid system are evaluated or assessed to determine whether they satisfy at least one or a set of well-formedness criteria before being processed further into code for deployment. In contrast to prior approaches, arbitrary predicates for describing invariants and guard conditions are replaced by more structured conditions such as, but not limited to, conditions related to clock constraints in timed automata [30]. The emulation system and method is also configured to use analytic solutions, rather than dynamic numerical solvers. Additionally, in this embodiment the emulation system and method is configured to employ synchronous semantics for the generated code that provides key advantages for modular compilation and sound transformations that are semantic preserving.

### 3.1 Well-Formed Hybrid Automata (WHA)

In one embodiment, optionally, a set is defined called CV(X) that will be used for creating constraints over the continuous variables. This is provided in Definition 3. These constraints are either comparison of a variable with a natural number or Boolean combinations of these. Comparisons can only be performed using the following mathematical operators: <,≤,>,≥.

Definition 3 Given a set of continuous variables X, then a set of constraints over these variables are defined as follows: g:=x<n|x≤n|x>n|x≥n|ĝg where, n∈N and x∈X. CV(X) denotes the set of constraints over X. Without loss of generality we can extend these constraints to the domain of rational numbers Q.

The well-formedness criteria may be varied depending on the requirements of the emulation.

In one embodiment, the emulation system and method may be configured for both modular code generation and to enable formal verification. In such embodiments, to be considered a WHA, an HA preferably satisfy the following set of well-formedness criteria or conditions (and which are defined in Definition 4):
(a) All invariants, jump and init predicates are members of the set CV(X).
(b) In HA semantics, when control resides in a location, there are infinite valuations of variables in any given interval of time. This makes code generation difficult. To facilitate code generation, we make evaluations only at discrete intervals. These intervals correspond to the ticks of a synchronous program that will be used for code generation.
(c) The ODEs which define flow constraints in any location of the form [symbol] =ƒ(x) must be closed form in nature. This property ensures that such ODEs are analytically solvable so that the witness functions needed for the generated code are analytically computable.
(d) All witness functions must be monotonic. This necessary property ensures that generated code can evaluate invariants and jump predicates using saturation rather than backtracking. This is detailed in Section 4.4.
   Definition 4 A well-formed hybrid automata

WHA= [symbol] Loc, Edge, Σ, Init, Inv, Flow, Jump [symbol] where
Loc={l₁, . . . , lₙ} representing n control modes or locations.
Σ=Σₗ∪Σ₀∪{τ} is the input alphabet comprising of event names, including internal events.
Edge⊆Loc×Σ×Loc are the set of edges between locations.
Three sets for the set of continuous variables, their rate of change and their updated values represented as follows:

X={x₁, . . . , xₘ}, { [symbol] = [symbol] .., [symbol] }, and

X′={x₁′, . . . , xₘ′}.
Init(l): x₁=v₁, . . . , xₘ=vₘ where v₁. . . vₘ∈R.
Inv(l): ∈CV(X)
Flow(l): A set of ODEs that meet the closed form requirement. Also, the witness functions of the ODEs are monotonic.
Jump(e): This function maps each edge ‘e’ to the conjunction of a guard and an update. The guard is in CV(X) and the update is in UP(X, X′), which specifies the value of the updated variables.
Fairness: the system never remains in any location indefinitely, i.e., if a location invariant holds indefinitely, then a egress transition is enabled by the controller within a bounded time.

The semantics of a WHA is also a TTS (Definition 2).

In another embodiment, the emulation system and method may be configured for modular code generation, and some of the well-formdness criteria or conditions above may be relaxed. For example, in such embodiments, to be considered a WHA, an HA must satisfy at least the following well-formedness criteria or condition:
The ODEs which define flow constraints in any location of the form [symbol] =ƒ(x) must be closed form in nature. This property ensures that such ODEs are analytically solvable so that the witness functions needed for the generated code are analytically computable.

One or more of the other well-formedness criteria above may optionally be included as restrictions also, depending on the requirements of the generated code for emulation.

### 3.2 Background on the Synchronous Approach

The synchronous approach [16] is widely used for the management of concurrency and race conditions. It is, in particular, applied extensively to the design of safety-critical systems, such as the embedded software for the Airbus A320 which uses the SCADE language and associated tools [21].

The synchronous approach is ideal for the development of reactive systems [31]. A reactive system reacts to its environment continuously and, in order to remain reactive, the speed of the environment must be considered, i.e. outputs must be produced for the current set of inputs before the next set of inputs appear.

The synchronous paradigm assumes that the idealised reactive system produces outputs synchronously relative to inputs, i.e., the outputs are produced after zero delay. This is possible if the reactive system executes infinitely fast relative to its environment, which is known as the synchrony hypothesis [16]. Based on this hypothesis, time may be treated as a sequence of discrete instants or ticks with nothing happening between the completion of the current tick and the start of the next tick. This idea is prevalent in various fields of engineering such as digital logic design and control systems [32]. Typically, the simulation step size of the ODE solver used for the plant must match the sampling step size of the controller for correct system simulation [33] and this aspect is often difficult to achieve. Unlike this, in the synchronous approach, the notion of synchronous composition [26] formalises this automatically using compilation technology.

The synchrony hypothesis is valid so long as the minimum inter-arrival time of input events is longer than the maximum time required to perform a reaction or tick. This requires the computation of the worst-case reaction time (WCRT) of the synchronous program [34], [35], [36].

Synchronous languages, which are based on the synchrony hypothesis, include Esterel [37], Lustre [38] and Signal [39], where every program reaction occurs with respect to a logical clock that ticks. A new reaction starts at the beginning of a tick by taking a snapshot of the input signals, computing the outputs using the user specified logic, and emitting the output signals before the next tick starts. This is similar to the scan cycle of a programmable logic controller [26].

### 3.3 Synchronous HA (SHA)

In this embodiment, the emulation system and method is configured to make semantic adaptations to the synchronous approach/model to facilitate code generation for hybrid systems that have continuous dynamics. By way of example, the emulation system and method is configured based on the following assumptions:
All ODEs can be solved using analytic methods to compute their witness functions.
Execution is performed in discrete instants based on the synchronous approach and the duration of each instant is a fixed time δ.
Due to the fairness assumption, the execution time spent in any location is always bounded.

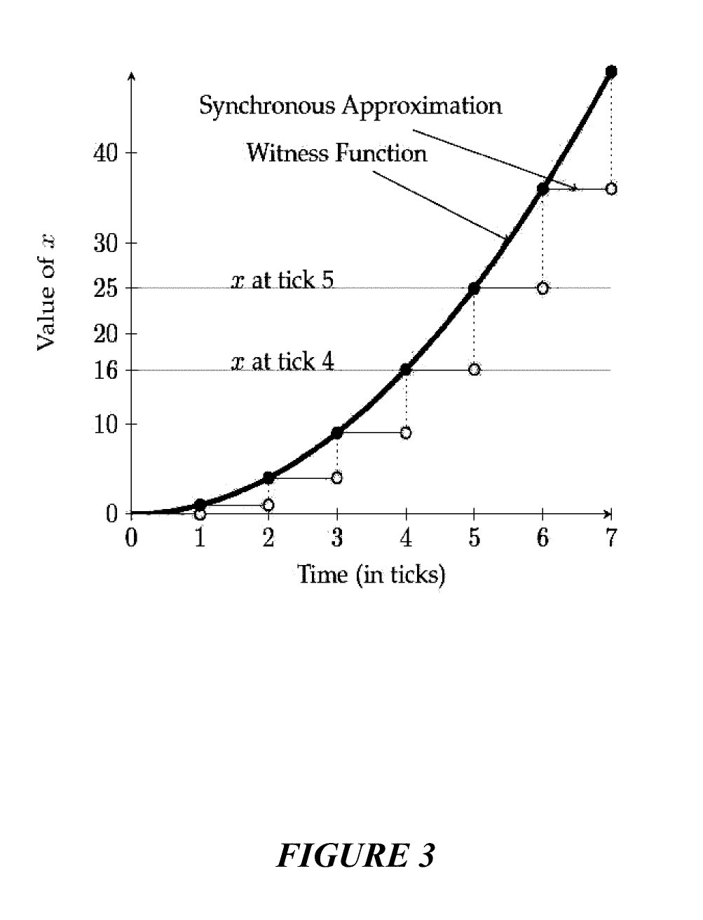

Based on these assumptions, Definition 5 formalises the concept of SHA corresponding to any WHA. A SHA provides an under-approximation of the behaviour of a WHA (a subset of behaviours) due to the fact that in an SHA, the valuation of continuous variables are made at discrete instants and the value remains constant between two distinct valuations. This is visualised in FIG. 3 and shows that the value of the continuous variable x is evaluated at discrete instants (or ticks) and remains unchanged between two instants (or ticks).

We also assume the following notation. Let ValueInterval={[N₁, N₂]|N₁∈N̂N₂∈N}
Definition 5 Given a well-formed hybrid automata

WHA= [symbol] Loc, Edge, Σ, Init, Inv, Flow, Jump [symbol] a SHA corresponding to this WHA is SHA= [symbol] Loc, Edge, Σ, Init, Inv, Switness, Jump, Step, Nsteps, BoundryCond [symbol] where:
Step=δ∈R⁺: This specifies the duration of the synchronous instant.
Nsteps: Loc→N: This specifies the maximum number of (logical) time steps that can be spent in any location. Nsteps(l)=k implies that during any execution of the SHA the time spent in l must be less than or equal to k×δ.
Switness: Loc×N×R×R^{m}→R^{m}: is the witness function that returns the valuation of all the continuous variables at any valid time step k in a given location l. It also takes as input the time step δ and the initial value from which execution begins in the location.
BoundaryCond: (X×Loc)→ValueInterval: This function defines the interval in which the boundary value of any continuous variable lies in a given location. The boundary value of a continuous variable x is the value of the variable at time 0, when execution starts in that location, i.e., x(0).

A SHA is an abstraction of the corresponding WHA. It inherits all the components of a WHA except that Flow predicates are replaced by a composite witness function Switness. Switness(l, k, δ, i)=v_{k,l,i}, which returns the evaluation of the witness function in location l at time step k. Here, v_{k,l,i} is a vector representing the valuation of variables in X. The following is used v_{k,l,i}(x)∈R to represent the valuation of the continuous variable x∈X in the k-th step in location l. The following shorthand x[k, l] is used to denote v_{k,l,i}(x) and the shorthand x[k] when the location l and the initial value of x in vector i, itself denoted as i(x) is clear from the context.

The emulaiton system and method is also based on other new components: Step, Nsteps, and BoundaryCond. Step specifies the duration of a discrete instant or tick and Nsteps maps every location to a natural number indicating the worst-case number of steps possible in that location during any execution of the SHA. Step can be any value on the positive real-number line, usually obtained via worst-case reaction time (WCRT) analysis, while Nsteps is computed statically using an algorithm presented in Section 4.2. BoundaryCond(l,x) returns a closed interval of the form [N₁, N₂], which means that the boundary value of x(0) in location l is in [N₁, N₂]. This mapping is essential for computing the constants of integration and is explained in Section 4.2.

The semantics of a Synchronous Hybrid Automata (SHA) is provided as a Discrete Time Transition System (DTTS) in Definition 6. It is assemed that all transitions of a DTTS trigger relative to the ticks of the logical clock of the synchronous program.

Definition 6 The semantics of a

SHA= [symbol] Loc, Edge, Σ, Init, Inv, Switness, Jump, Step, Nsteps, BoundaryCond [symbol] is a DTTS= [symbol] [symbol] , [symbol] ⁰, Σ, → [symbol] where
The state-space is [symbol] , where any state is of the form (l, v, i, k) where l is a location, i is the initial valuation of the variables when execution begins in the location and v is the valuation at the k-th instant.
[symbol] ⁰⊆ [symbol] where every q⁰∈Q is of the form (l, v⁰, i, k) such that v satisfies Init(l).
Transitions are of two types:
   Inter-location transitions that lead to mode switches: These are of the form

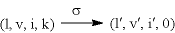

if (l, v, i, k)∈ [symbol] , (l′, v′, i′, 0)∈ [symbol] ,

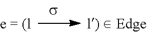

and (v, v′) satisfy Jump(e).
Intra-location transitions made during the execution in a given mode/location: These are of the form (l, v, i, k)→(l, v′, i, k+1) if (l, v, i, k)∈ [symbol] , (l, v′, i, k+1)∈ [symbol] , (v, v′) satisfy Inv(l), Switness(l, k, δ, i)=v and Switness(l, k+1, δ, i)=v′.

### 3.4 SHA Semantics and Composition

The above developed synchronous semantics for the emulation system and method enables modular code generation. In this embodiment, the emulation system and method is configured to compile each WHA separately in the modulation compilation step 16 in FIG. 1A and then the generated codes are linked together in the linking operation step 18. The synchronous parallel composition of SHAs is formalsied in Definition 7. This facilitates the seamless linking process, described in Section 4.5.

### Definition 7 Given

SHA₁= [symbol] Loc₁, Edge₁, Σ₁, Init₁, Inv₁, Switness₁, Jump₁, Step₁, Nsteps₁, BoundaryCond₁ [symbol] : DTTS₁= [symbol] [symbol] ₁, [symbol] ₁⁰, Σ, →₁ [symbol] and

SHA₂= [symbol] Loc₂, Edge₂, Σ₂, Init₂, Inv₂, Switness₂, Jump₂, Step₂, Nsteps₂, BoundaryCond₂ [symbol] : DTTS₂= [symbol] [symbol] ₂, [symbol] ₂⁰, Σ₂,→₂ [symbol] and Sharedᵥ=X₁ [symbol] X₂ and Sharedₑ=Σ₁ [symbol] Σ₂ denoting a set of shared variables and events, respectively, which satisfy the following conditions:
1. All writes to shared variables x∈Sharedᵥ or the emission of shared events e∈Sharedₑ are mutually exclusive.
2. Any read to a shared variable x∈Sharedᵥ or a shared event e∈Sharedₑ accesses the value of the variable/event in the previous tick, denoted pre(x)/pre(e).

DTTS₁∥DTTS₂=DTTS [symbol] [symbol] , [symbol] ⁰, Σ, → [symbol] where:
The state-space is [symbol] ⊆ [symbol] ₁× [symbol] ₂.
[symbol] ⁰⊆ [symbol] ₁⁰× [symbol] ₂⁰.
Transitions→are of two types:
   Inter-location transitions of the form:

### (Rule Inter-Inter)

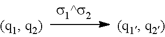

where q₁=(l₁, v₁, i₁, k), q₂=(l₂, v₂, i₂, k), q_{r′}=(l_{1′}, v_{1′}, i_{1′}, 0),

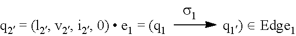

and (v_{1′}, v_{1′})satisfy Jump(e₁).

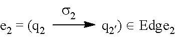

and (v₂, v_{2′}) satisfy Jump(e₂).

### (Rule Inter-Intra)

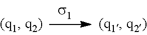

where q₁=(l₁, v₁, i₁, k), q₂=(l₂, v₂, i₂, k), q_{1′}=(l_{1′}, v_{1′}, i_{1′}, 0),

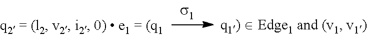

satisfy Jump(e₁). q₂, q_{2′}∈ [symbol] ₂ and (v₂, v_{2′}) satisfy Inv(l₂). Finally, i_{2′}=v₂ and v_{1′}=v₁.

### (Rule Intra-Inter)

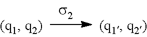

where q₁=(l₁, v₁, i₁, k), q₂=(l₂, v₂, i₂, k), q_{1′}=(l₁, v_{1′}, i_{1′}, 0),

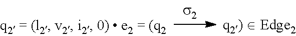

and (v₂, v_{2′}) satisfy Jump(e₂). q₁, q_{1′}∈ [symbol] ₁ and (v₁, v_{1′}) satisfy Inv(l₁). Finally, i_{1′}=v₁ and v_{1′}=v₁.
Intra-location transitions of the form:
   (Rule Intra-Intra) (q₁, q₂)→(q_{1′}, q_{2′}) where q₁=(l₁, v₁, i₁, k), q₂=(l₂, v₂, i₂, k), q_{1′}=(l₁, v_{1′}, i₁, k+1), q_{2′}=(l₂, v_{2′}, i₂, k+1), and q₁, q_{1′}∈ [symbol] ₁, (v₁v_{1′}) satisfy Inv(l₁), Switness(l₁, k, δ, i₁)=v₁ and Switness(l₁, k+1, δ, i₁)=v_{1′}. Similarly, q₂, q_{2′}∈ [symbol] ₂, (v₂, v_{2′}) satisfy Inv(l₂), Switness(l₂, k, δ, i₂)=v₂ and Switness(l₂, k+1, δ, i−2)=v_{2′} for any δ.

In Definition 7, the DTTS corresponding to two SHAs composed in parallel is computed by composing their respective DTTSs. The state-space [symbol] of the resultant DTTS is a subset of the product of the state-space of the individual constituents. The initial state-space [symbol] ⁰ is also a subset of the product of the initial state-space of the constituents. The transition relation consists of two types of transitions. The inter-location transitions happen when any one of the constituents or both constituents make an inter-location transition (there are three different possibilities). Rule Inter-Inter states that both constituents can take a discrete transition to new locations.

Rule Inter-Intra states that when the first constituent [symbol] ₁ takes an inter-location transition from location l₁ to l_{1′}, [symbol] ₂ is also forced to make such a transition. But, the resultant location of [symbol] ₂ does not change, i.e., [symbol] ₂ can only take a transition from l₂ to l₂. Moreover, upon taking the transition the initial value i₂ is set to the current valuation v₂, consequently implying that v_{2′}=v₂. Once in the new state (l_{1′}, l₂) vectors v₁ and v₂ start evolving according to their individual witness functions. Rule Intra-Inter is the dual of Rule Inter-Intra. Finally, intra-location transition in the composition (Rule Intra-Intra) happens only when both constituents make an intra-location transition.

### 4. Methodology for Code Generation

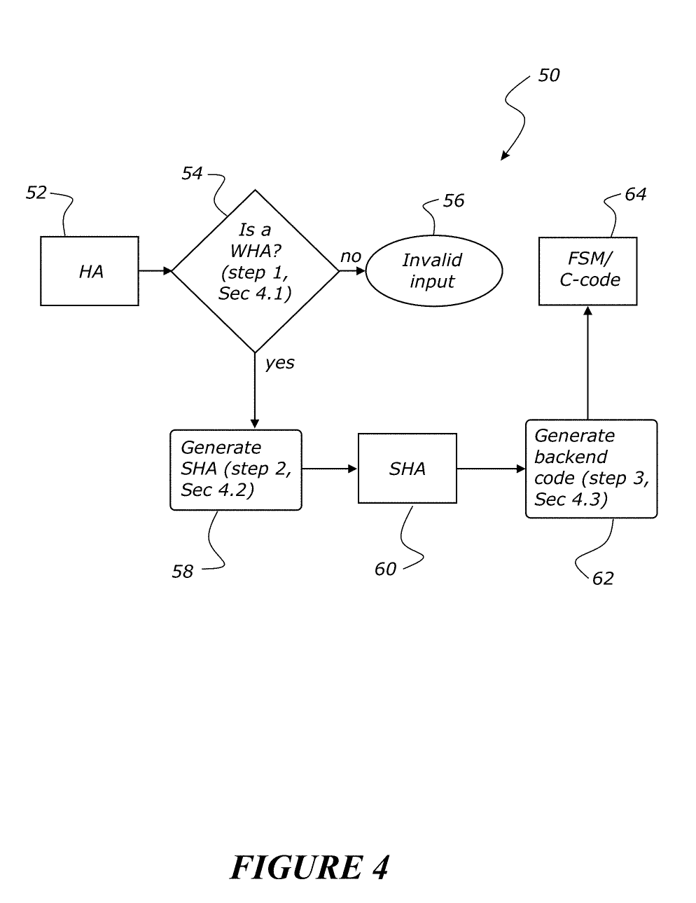

By way of example, the process 50 used to compile or generate code for a single HA in an embodiment of the emulation system and method will be described with reference to FIG. 4. This code generation or compilation process 50 relates to the verification and modulation compilation steps 14, 16 described in the overview. The emulation system and method may be configured to compile each HA of the network of one or more HAs defining a hybrid system either in parallel or sequentially, or a combination, e.g. sequentially processing groups of two or more HAs.

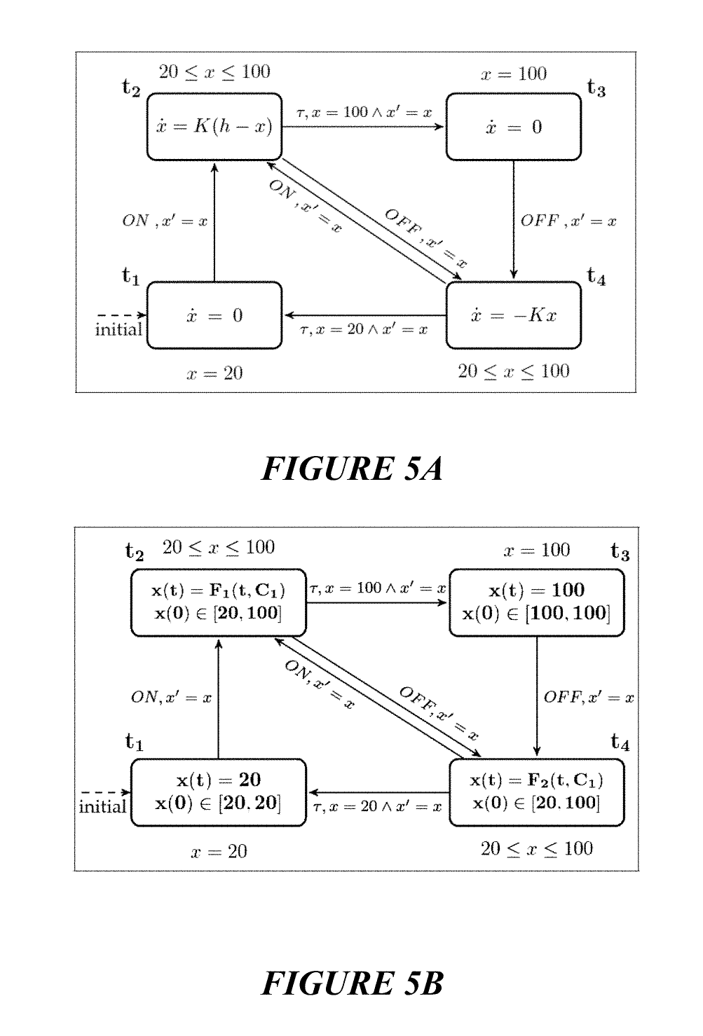

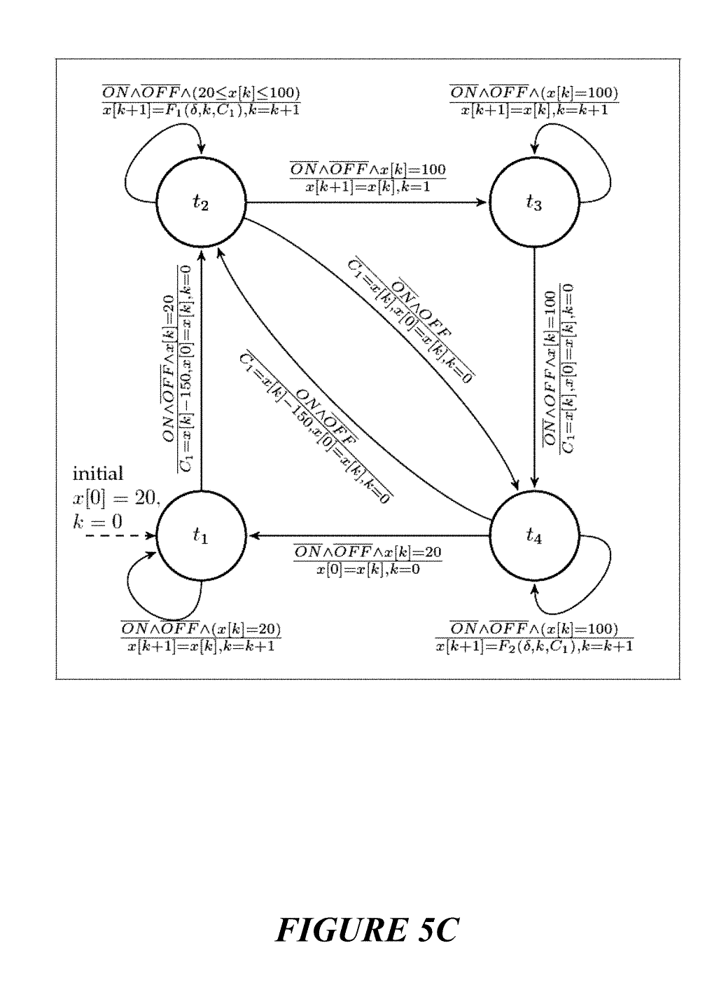

In this embodiment, the code generation for each HA comprises three main steps. By way of example, all three steps will be descirbed in Sections 4.1-4.3 using the water tank HA (reproduced in FIG. 5A) of the water tank heating system 30 described previously with reference to FIGS. 2A-2D.

### 4.1 Static Analysis of Hybrid Automata

Referring to FIG. 4, the HA code generation or compilation process 50 is configured to receive or retrive data indicative of the HA 52 to be processed. The first step in the code generation process is a verification step 54 to statically determine if the one or more well-formedness criteria defined in Section 3.1 are satisfied or respected for the input HA. If the HA does not respect the one or more predefined or pre-configured stored well-formedness criteria, then an error is generated as shown at 56, which halts the code generation for that HA.

By way of example, the procedure to verify the well-formedness criteria is presented in Algorithm 1, which takes an HA as input. In this example, the system is configured such that three well-formedness criteria need to be satisfied, although as previously mentioned the criteria may be relaxed to only require that ODEs have a closed form solution in altnerative embodiments. First, the invariants and the jump conditions need to be of the form CV(X) (Definition 3). Lines 2-14 guarantee that this criterion is met. The second and third criteria require that each ODE, in every location, of the HA should have a closed form solution and should be monotonic. Lines 15-30 ensure that these criteria are satisfied.

Algorithm 1 The algorithm to check the well-formedness criteria of a HA

Input: HA ha
Output: Boolean

| | |
|---|---|
| 1: | gset ← ∅ |
| 2: | for all edges ϵ ha do |
| 3: | for all guards ϵ edges do |
| 4: | gset ← gset ∪ guards |
| 5: | end for |
| 6: | end for |
| 7: | for all loc ⊂ ha do |
| 8: | for all invs ϵ loc do |
| 9: | gset ← gaset ∪ invs |
| 10: | end for |
| 11: | end for |
| 12: | for all g ϵ gset do |
| 13: | assert type(g) ϵ CV (X) |
| | // check that all location invariants and jump conditions are of type CV (X) |
| 14: | end for |
| 15: | for all loc ϵ ha do |
| 16: | for all ode ϵ loc do |
| 17: | if solve_ode(ode) then |
| 18: | (R₁, R₂) ← solve(ode.rhs > 0) |
| 19: | (R₁′, R₂′) ← solve(ode.rhs < 0) |
| 20: | [N₁, N₂] ← get_inv_bounds(ode, loc) |
| 21: | if (R₁, R₂) ∩ [N₁, N₂] ≠ ∅ ∧ (R₁′, R₂′) # [N₁, N₂] ≠ ∅ then |
| 22: | throw Exception (“Not a WHA”) // Slope of witness function, changes sign |
| 23: | else |
| 24: | return True |
| 25: | end if |
| 26: | else |
| 27: | throw Exception(“Not a WHA”) / /\|No closed form solution, hence not a WHA |
| 28: | end if |
| 29: | end for |
| 30: | end for |

With reference to the running example HA—the water tank system presented in FIG. 5A—lines 2-14 in Algorithm 1 collect all the invariant and jump conditions from the locations and the edges, respectively. Once collected in set gset, an assertion statement guarantees that all these conditions are of the form CV(X) (line 13). Lines 15-30 iterate through each location of the HA. Upon visiting a location, all ODEs within the location are solved symbolically (line 17). If no closed form solution exists, then an error is generated (line 27).

Given that a closed form solution exists, the process is then configured to guarantee that all ODEs in a location are monotonic (although not necessarily strictly monotonic). For exameple, in this embodiement the system and method is configured such that any given (witness) function is considered monotonic iff: the first derivative of the function does not change sign [40]. In this case, flow conditions evolve one or more ODEs within a given location as long as the invariant on the location is not violated. Therefore, the definition of a monotonic function can be made more specific, such as: any given (witness) function is monotonic iff its first derivative does not change sign within the interval specified by the invariant(s) of the location.

The right hand side of the ODEs specify the first derivatives of the witness functions. The system is configured to ensure that the right hand side expression of the ODE (the slope) does not change signs within the invariant bounds. The lines 18-22 of Algorithm 1 ensure that these conditions are satisfied. Line 18 obtains the real number line interval (denoted by (R₁, R₂)) such that the derivative of the witness function is always greater than zero, i.e., an increasing function. Line 19 obtains the real number line interval (denoted by (R₁′, R₂′), such that the first derivative of the witness function is less than zero. Next, we obtain the invariant interval (denoted [N₁,N₂]), bounding the value of the evolving variable in the ODE, from the invariant(s) on the location. A non-empty interval (R₁, R₂)∩[N₁, N₂] indicates that the witness function is increasing within the location intervals. Similarly, a non-empty interval (R₁′, R₂′)∩[N₁, N₂] indicates that the witness function is a decreasing function within the location invariants. If both sets are non-empty, the witness function increases and decreases within the invariants specified on the location, and hence, the witness function is not monotonic.

By way of example with reference to the water tank running example in FIG. 5A, the steps to determine if the witness function in location t₂ is monotonic are as follows:
1. Compute the real number line interval for x such that the right hand side of the ODE is strictly greater than zero: x∈solve((0.075*(150−x)>0) gives; x∈(−∞, 150)
2. Compute the real number line interval for x such that the right hand side of the ODE is strictly less than zero: x∈solve((0.075*(150−x)<0) gives; x∈(150, ∞)
3. Get the invariants bounds on x: For location t₂ this interval is obtained from interval: 20≤x≤100. Hence, the invariant bounds are: x∈[20, 100].
4. Check if the witness function is monotonic: The intersection (−∞, 150)∩[20, 100]=[20, 100], but (150, ∞)∩[20, 100]=Ø, and hence, the witness function in location t₂ is an increasing (and monotonic) function.

For the running example in FIG. 5A, all the well-formedness criteria are satisfied and hence, the water tank HA is a WHA. As such, the code generation or compilation process 50 then moves to the second step 58, described below.

### 4.2 Generation of SHA

This section describes the second step 58 in the code generation or compilation process 50 from FIG. 4. Once a given input HA is determined to be a WHA in the verification step 54, an SHA 60 is generated from the WHA in the SHA generation step 58. The SHA generation step 58 translates all ODEs in every location of the WHA into their closed form solutions (witness functions). In this embodiment, the SHA generation step 58 is also configured to compute the worst-case bound Nsteps (if one exists) as defined in Definition 5.

In this embodiment, by way of example only, the procedure to generate a SHA 60 from a WHA is presented in Algorithm 2. In this configuratin, Algorithm 2 visits every location in the WHA. For each ODE in the location, a witness function is obtained (line 4). Next, the algorithm attempts to find the time that the HA will spend in every location (lines 6-18) in the worst-case. The algorithm first detects the slope of each ODE (ode in Algorithm 2) for any given location (loc in Algorithm 2), by differentiating the witness function with respect to time t (line 6). If the slope is increasing (line 6) then the witness function (eq in Algorithm 2) is solved for t. The reverse is applied for an ODE with decreasing slope (line 9). If the slope is constant, in case of a non-changing ODE, a warning is raised stating that egress (fairness) condition is needed to make progress out of the location (line 11). Given the various worst-case times in the set times, for all ODEs in a location, the minimum value amongst times needs to be bounded to guarantee at compile time that Nsteps is bounded, otherwise an egress condition is needed to make progress out of the location (line 17).

Algorithm 2 The algorithm to generate a SHA from. a WHA

| Input HA ha | |
|---|---|
| Output: SHA sha | |
| 1: | for all loc ϵ ha do |
| 2: | for all ode ϵ loc do |
| 3: | times ← ∅ |
| 4: | eq ← solve_ode(ode) |
| 5: | ode ← eq |
| 6: | if sign(diff(eq, t)) > 0 then |
| 7: | times ← times ∪ solve(eq, min(Init), max(Inv)) |
| 8: | else if sign(diff(eq, t)) < 0 then |
| 9: | times ← times ∪ solve(eq, max(Init), min(Inv)) |
| 10: | else |
| 11: | raise Warning (“Fairness required”) |
| 12: | times ← 0 |
| 13: | break |
| 14: | end if |
| 15: | end for |
| 16: | if min(times) = ∞ then |
| 17: | raise Warning (“Fairness required”) |
| 18: | end if |
| 19: | end for |
| 20: | return this |

With reference to the running water tank exmaple, the generted SHA is shown in FIG. 5B. The algorithm visits each location in the WHA (FIG. 5A) and replaces each ODE with its equivalent closed form solution (Algorithm 2, line 5). The closed form solution of all ODEs for the water tank is shown in FIG. 5B, given h=150 and K=0.075, respectively.

With referecne to location t₁ in FIG. 5B, line 6, in Algorithm 2, differentiates the witness function with respect to time (t), resulting in a sign of 0, indicating a non-changing witness function. Hence, a warning that an egress transition is needed to make progress out of location t₁ is raised. This is expected, because as seen in FIG. 5A, the ODE [symbol] =0 does not change the value of x and the invariant x=20 holds, hence progress out of location t₁ is only possible upon reception of (egress) event ON.

Similarly, differentiating the witness function with respect to time in location t₄, gives the solution −0.075×C1, where C1 is the constant of integration. In this embodiment of the system and method, the data defining the input HA comprises, for every location, data indicative of the possible range of (initial) values that the continuous variable(s) might take upon entering the location. For example, BoundaryCond(t₄,x) is denoted as x(0)∈[20, 100] for location t₄ (the possible initial value intervals can be computed automatically from the HA). Given that the initial value interval is positive, the slope of the witness function is detected to be negative (since C1 can only take a positive value) and hence, the witness function in location t₄ is a decreasing function. Once this is deduced, the worst-case time spent in location t₄ is computed at line 9, in Algorithm 2, by substituting the initial value of x as the maximum value from the ValueInternal, i.e., x(0)=max(20, 100)=100 and the final value of x as the minimum value from amongst the invariant on x in location t₄, i.e., x(l)−min(20, 100)=20.

Given that the witness function x(t) is a decreasing function with an initial value of 100, the system computes, using solve on line 9, the time t it takes for function x(t) to reach its final value 20. This time t, if it can be computed, gives the maximum time that the system will remain in location t₄ before making progress to a new location. In this embodiment, the solve procedure proceeds as follows:
1. Compute the value of the constant of integration: For location t₄, x(t)=C₁×e^{-0.075×l} as shown in FIG. 5B. First of all, we compute the constant of integration, using the initial value x(0)=100⇒100=C₁×e^{-0.075×0}⇒C₁=100⇒x(t)=100×e^{-0.075×1}.
2. Computing time t: Once, we have computed the constant of integration, we can easily compute the time t it takes for the witness function, x(t) in location t₄, to decrease from 100 to 20 as follows:

$$x ( t ) = 20 ⇒ 20 = 100 \times {e}^{- 0.075 x 1} ⇒ t = \frac{ln ( \frac{20}{100} )}{- 0.075} ⇒ t \approx 214.6 .$$

The system will make progress out of location t₄, in the worst-case, after approximately, 214.6 units of time. Similarly, the system can be configured to bound the worst-case time spent in a location with increasing, rather than decreasing witness functions. In case a location consists of multiple witness functions, the worst-case time spent in that location is the minimum amongst the worst-case times computed for all the witness functions in that location. If the minimum amongst all the worst-case times is ∞, then a warning stating that an egress transition is necessary to make progress out of a location is generated as seen on line 17 in Algorithm 2.

### 4.3 Backend Code Generation

Finally, this section describes the third and last step 62 in the code generation or compilation process 50 from FIG. 4. After the verification of WHA requirements 54 and the generation of the SHA 58, the procees progresses to the backend code generation step 62. The backend code generation step receives data indicative of the SHA 60 and processes that to generte the backend code, such as C-code or a finite state machine (FSM) for example. In this embodiment, in the backend step 62, the SHA 64 is represented as a Synchronous Witness Automata (SWA), which captures the behaviour of the SHA 60 as a synchronous state machine. The SWA is a discrete variant which, when executed, produces the desired behaviour as a DTTS (Definition 6). During the execution, a task known as saturation may also be needed while taking discrete transitions. This is formalised in Section 4.4. The SWA is formalised using Definition 9, and also by defining CV(X[k]) in Definition 8 that is essential for the definition of the transition relation of an SWA.

Definition 8 Let x[k] denote the k-th (k∈N) valuation of any variable x∈X and let X[k] denote the set of all such k-valuations of variables in X.

We denote CV(X[k]) the set of constraints over X[k]:

g:=x[k]<n|x[k]≤n|x[k]>n|x[k]≥n|ĝg where, n∈N.

Definition 9 A synchronous witness automata (SWA)

S= [symbol] S, S₀, Σ, X, Updates,→ [symbol] , which corresponds to the SHA= [symbol] Loc, Edge, Σ, Init, Inv, Switness, Jump, Step, Nsteps, BoundaryCond [symbol] where
S denotes the set of states of S and S=Loc.
S₀ is a subset of initial states.
Σ is a set of events.
X is a set of continuous variables
Updates represent a set of updates. A given update may capture the emission of an output event, the update of a state variable in a given tick using its witness function or the initialization of an integration constant or the time instant.
→⊆S×B(Σ)×CV(X[k])×2^{Updates}×S represents the transition relation. Here B(Σ) denotes the set of Boolean formulas over Σ.
   We use the shorthand,

$$( s , \frac{e g}{u} , {s}^{′} )$$

to represent transitions. Here, e∈B(Σ), g∈CV(X[k]) and u∈2^{Updates}.
The generated C-code is an SWA. With refernce to the running example, the SWA for the water tank generated from the SHA (FIG. 5B) is shown in FIG. 5C. Every location in the SHA has an equivalent state in the SWA, as shown in FIG. 5C. Furthermore, the witness functions in the locations of the SHA are moved to transitions in the SWA. For example, the SWA self-transition from state t₂ to t₂ represents the evolution of the continuous variable x in discrete steps k∈[0, Nsteps]. In the SWA of FIG. 5C, the transitions are labelled with the form:

$$\frac{antecedent}{consequent} .$$

The self-transition from state t₂ to state t₂ is labeled as:

$$\frac{\overline{ON} \overline{OFF} ( 20 \leq x [ k ] \leq 100 )}{x [ k + 1 ] = {F}_{1} ( d , k , {C}_{1} ) , k = k + 1} ,$$

which states that while the value of x at tick k is between 20 and 100 and no events (ON or OFF) are detected, x evolves to the new value depending upon the witness function F₁. C₁ is the constant of integration. The transition guard has a one-to-one correspondence with the invariant condition on location t₂ in FIG. 5B. Self-transitions are added to all states of the generated SWA, which evolve all the continuous variables in the corresponding location in the SHA. The generated SWA also consists of all the edges from the SHA, e.g., transition

$$\{ {t}_{2} , \frac{ON \overline{OFF} x [ k ] = 20}{{C}_{1} = x [ k ] - 150 , x [ 0 ] = x [ k ] , k = 0} , {t}_{3} \} ,$$

which corresponds to the jump and updates on the transition between locations t₂ and t₃ in the corresponding SHA in FIG. 5B.

The C-code 64 representing the SWA in FIG. 5C is shown in Table 1 below, although only the states t₁ and t₄ along with their associated transitions and functions are shown. There is a literal one-to-one correspondence between the SWA in FIG. 5C and the C-code in Table 1. We use the variables x and x_u to denote the x[k] and x[k+1] valuations of the continuous variable x, respectively. The witness functions are represented as functions in C (e.g., lines 1-10 in Table 1).

TABLE 1
C-code generated for the SWA in FIG. SC

| | |
|---|---|
| 1 | double t4_ode_l (double d, double k, double C1) { |
| 2 | return C1*exp (−0.075*d*k); |
| 3 | } |
| 4 | double t4_init_1 (double x_u) { |
| 5 | return − x_u; |
| 6 | } |
| 7 | enum states watertankR (enum states cstate, |
| 8 | enum states pstate) { |
| 9 | switch (cstate) ( |
| 10 | case (t1): |
| 11 | if (x == 20 && !ON && !OFF) { |
| 12 | if (pstate != cstate) C1 = t1_init_1 (x); |
| 13 | x_u = t1_ode_1 (C1); |
| 14 | k=k+1; |
| 15 | cstate = t1; |
| 16 | } |
| 17 | else if (ON && !OFF) { |
| 18 | k=1; cstate=t2; x_u = x; |
| 19 | } |
| 20 | break; |
| 21 | case (t2) : ... |
| 22 | case (t3) : ... |
| 23 | case (t4) : |
| 24 | if (x >= 20 && x <= 100 && !ON && !OFF) { |
| 25 | if (pstate != estate) C1 = t4_init_1 (x); |
| 26 | x_u = t4_ode_1 (d, k, C1); |
| 27 | k=k+1; |
| 28 | cstate = t4; |
| 29 | } |
| 30 | else if (ON && !OFF) { |
| 31 | k=0; cstate=t2; x_u = x; |
| 32 | } |
| 33 | else if (!ON && !OFF && x == 20) { |
| 34 | k=0; estate=t1; x_u = x; |
| 35 | } |
| 36 | break; |
| 37 | } |
| 38 | return cstate; |
| 39 | } |

The witness functions are incomplete, in the sense that the value of the constant of integration (e.g., C1 on line 3) needs to be computed. Computing this constant of integration is equivalent to solving the initial value problem. The value of the constant of integration, in the witness function, depends upon the initial value of the witness function. The initial value, at time 0, of any witness function is either: (1) the specified initial value of the continuous variable that the witness function updates, as shown in FIG. 5C with the dashed arrow, or (2) the updated value of the continuous variable on an Inter location transition.

Consider the two transitions, one from location t₂ to t₄ and the other from t₄ to t₂ in FIG. 5C. Variable x is updated by the witness function F₂ on the self-transition in state t₄. Function F₂ takes as input arguments the current tick number, k∈N, the step size of the tick, δ∈R⁺, and the constant of integration. The argument k starts from 0 and δ is a constant. The value of the constant of integration is determined when entering state t₄, by making C₁ the subject. Since F₂=C₁×e^{δ×k×-0.075}, we set k=0 and making C₁ the subject gives C₁=F₂(0), i.e., C₁ takes the value of x[0], which as we know from FIG. 5B is the final value of x in the previous state, since x′=x. Hence, C₁=x[k] is obtained. In Table 1, the constant of integration C1 is updated whenever any state is entered for the first time (line 16) this corresponds to the update of the constants of integration on the transitions in FIG. 5C.

### 4.4 Saturation

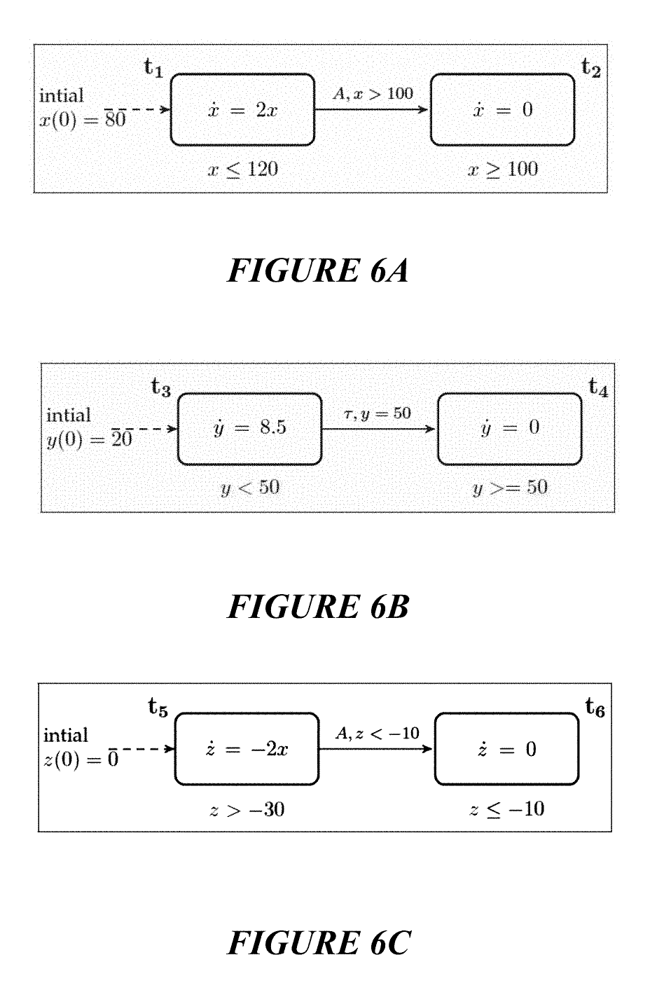

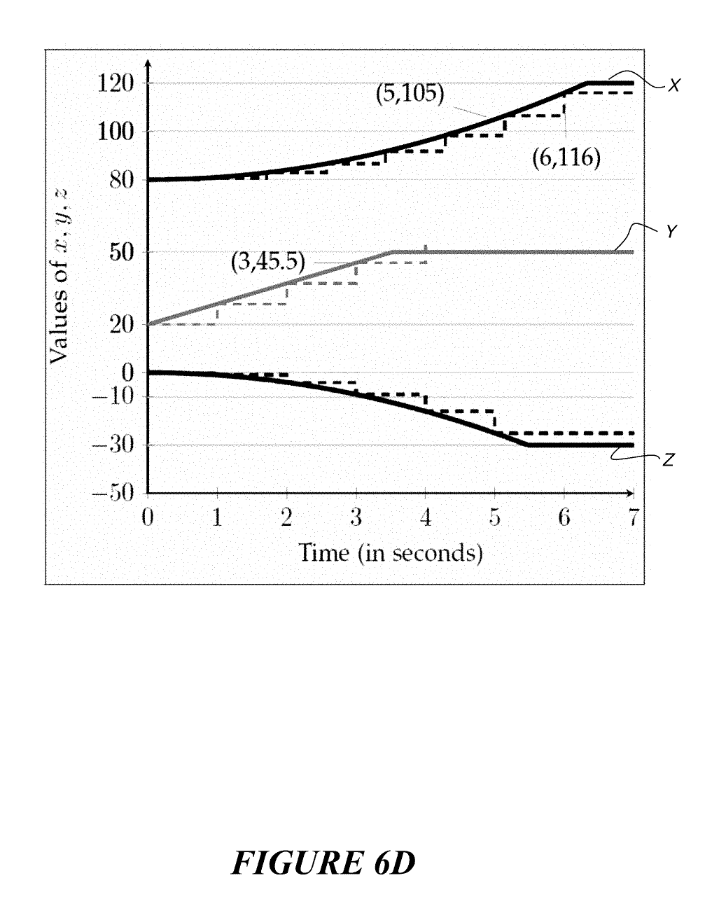

Due to the discrete/synchronous valuation of variables, when control remains in one location the variable may reach a value which will never satisfy the guard condition of the egress transition. This phenomena depends on the location invariant and the guard and may not happen frequently. FIGS. 6A-6D illustrates three separate cases.

Case 1: FIG. 6A illustrates a case where there is no need for saturation. For location t₁, the invariant is x≤120 and the jump condition is Âx≥100. According to the non-deterministic semantics of hybrid automata, the value of x, as it leaves location t₁, can be in the interval (100, 120] when the signal A is present. The value of x is plotted against time in FIG. 6D (top). In the synchronous approximation (shown as a dashed line), the value of x when it leaves location t₁ is either 105 or 116 (tick length of one second). Note that the trace due to the synchronous approximation is different but, still a valid trace of HA.

This example satisfies the restrictions proposed by Alur et al. [23] and will be accepted for code generation. Here, the duration between the occurrence of the jump condition evaluating to true and the occurrence of the invariant evaluating to false is longer than the tick length (sampling period). This restriction ensures that there is always at least one valid state where a discrete transition can be taken. However, this may not always be possible as shown in the following case.

Case 2: FIG. 6B illustrates a case where there is a need for saturation. FIG. 6D (middle) shows the value of y increasing steadily to 50 and then remaining at 50. In contrast to Case 1, for location t₃ the duration between the occurrence of the guard (y=50) evaluating to true and the occurrence of the invariant evaluating to false (y<50) is zero. This violates the restrictions proposed in [23] and this HA would not be accepted. In Simulink, this HA may not be simulated correctly because of the equality check. In fact, for two out of seven benchmarking examples, we observed incorrect behaviour (see Table 3 in Section 5).

In the synchronous approximation, the HA is accepted because of the proposed saturation technique. In this embodiment of the system, during the 4^{th} tick the value of y is below 50 and the guard condition is not satisfied. During the 5^{th} tick the value of y is above 50 (see FIG. 6D) and without saturation this leads to an unreachable state because neither the invariant (y<50) of t₃ nor the guard (y=50) are valid. To address this problem, at the start of the 5^{th} tick, the value of y is saturated to exactly 50. Hence, a value greater than 50 is not observed between ticks 4 and 5. By using saturation, unlike the work by Alur et al. [23], we are agnostic to the step size (sampling period).

Case 3: FIG. 6C illustrates a decreasing function where, similar to Case 1, there is no need for saturation. Once again, the duration between the occurrence of the guard evaluating to true and the occurrence of the invariant evaluating to false is longer than the step size (sampling period). This restriction ensures that there always exists at least one valid state where a discrete transition can be taken. This HA is accepted for code generation by [23] and by the embodiment of emulation system and method described.

Definition 10 formalises this saturation technique.

Definition 10 In any discrete time instant k, when execution makes a discrete switch from state l to l′ in the SWA, the valuation of all continuous variables X[k] either satisfy the guard condition g∈CV(X[k]) or are set to a suitable value such that g is satisfied. This is termed as saturation.

According to the above definition, during the execution of the backend code 64, the system is configured to decide dynamically when to saturate and also decides on the correct saturation value. This decision is based on the following Lemma that ensures that the value of x[k] that satisfies the guard always exists in the current discrete step.

Lemma 1 It is always possible to uniquely determine the saturation value for any continuous variable at time instant k when the state (location) switch from l to l′ is to be taken in a SWA.

Proof. The proof of this lemma follows from the following observations.
Observation 1: All witness functions x(t) for any x∈X are monotonic in every location (WHA requirement).
Observation 2: All witness functions x(t) for any x∈X are continuous as they are differentiable in any interval.
Observation 3: Given the above two observations, the saturation value for any variable x always exists in the time interval [(k−1)×δ, k×δ] when the location switch happens at instant k×δ.

### 4.5 Composistion of SHAs

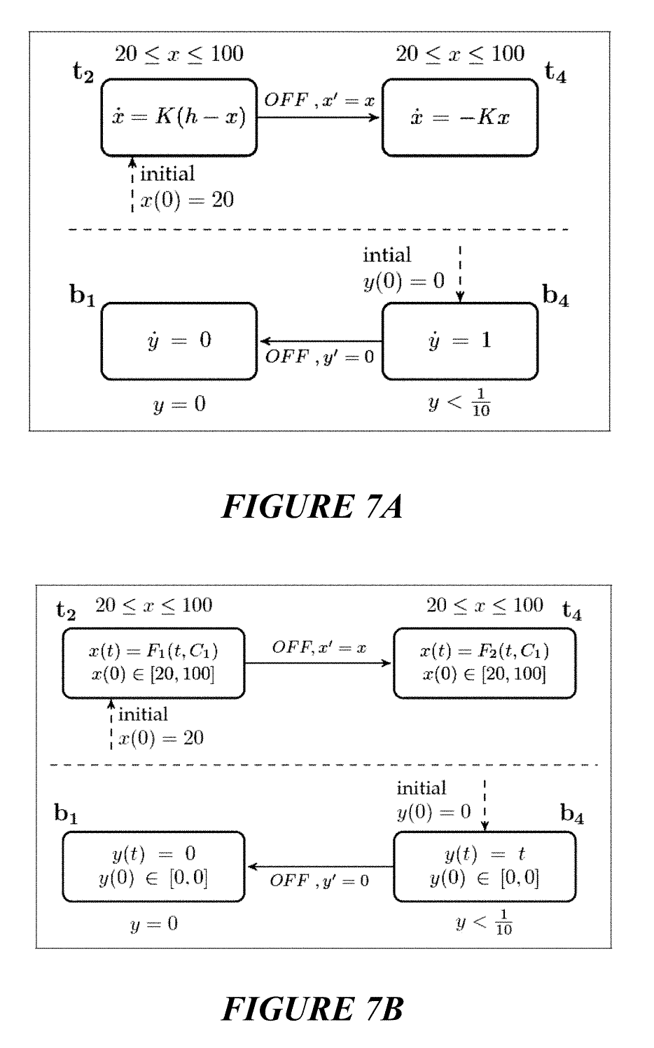

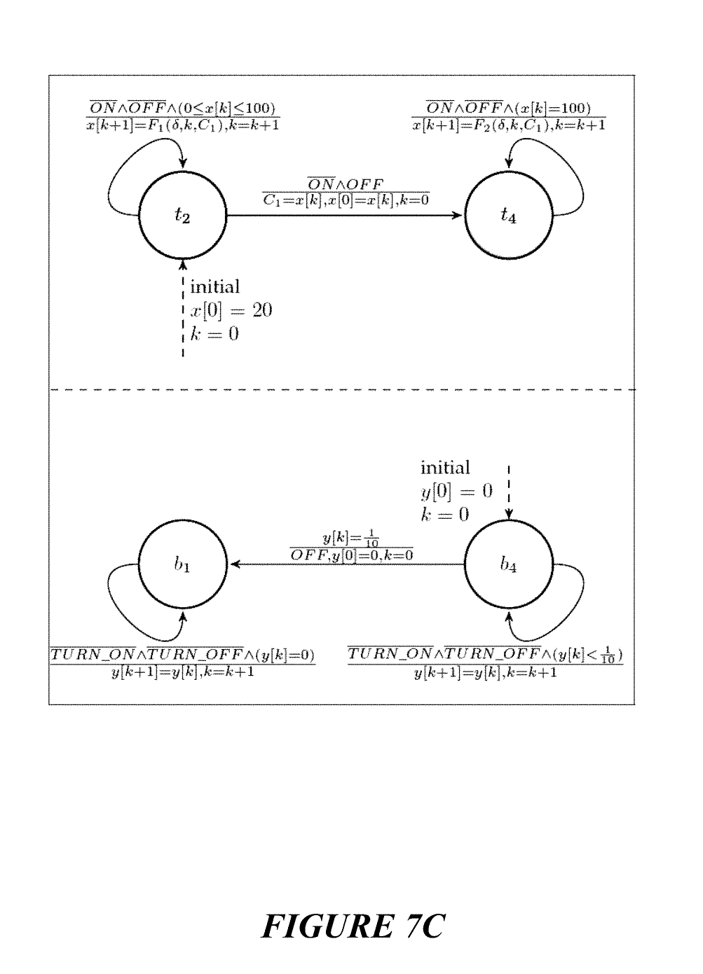

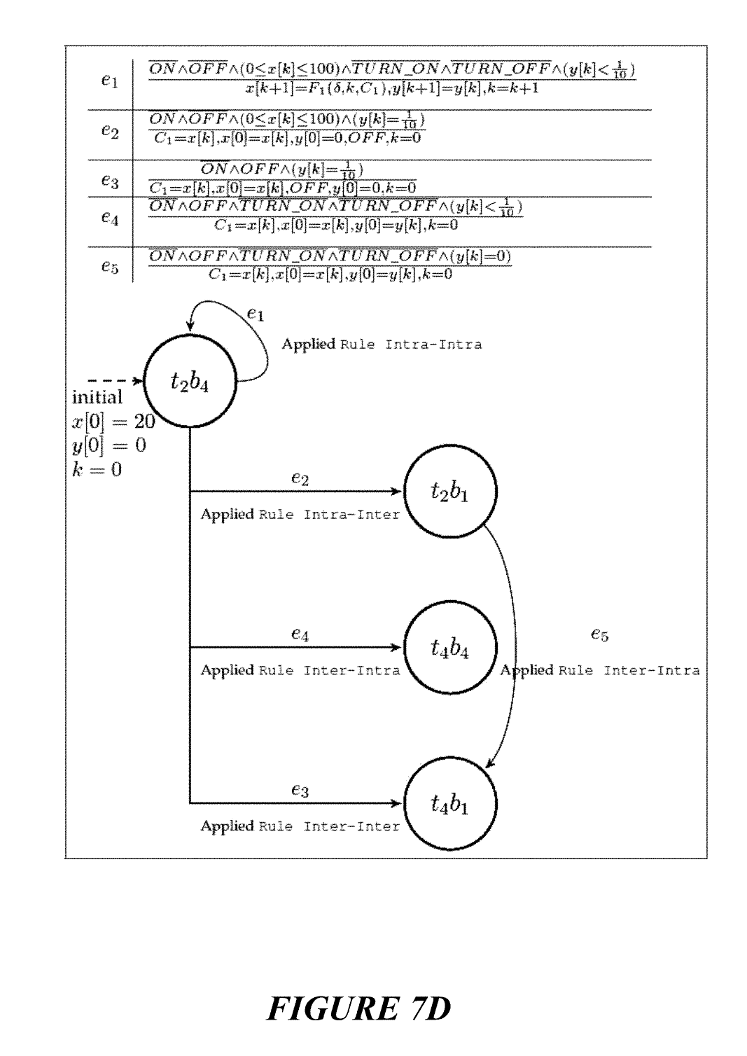

This section describes the modular compilation and linking steps 16, 18 of the process 10. In this embodiment, the modulation compilation of SHAs uses the composition rules defined in Definition 7. This will be decribed with reference to the water tank and gas burner HAs of the running example as shown in FIG. 7A. The equivalent partial SHAs for these two HAs are shown in FIG. 7B. As described previously, in Section 4.2, the ODEs (flow predicates) in each location have been replaced with their individual witness functions. The system is then configured to compile these SHAs into individual SWAs as shown in FIG. 7C. The composition rules defined in Definition 7 are applied on these resultant SWAs to generate a single SWA shown in FIG. 7D.

The pseudo-code used to compose two SWAs is shown in Algorithm 3. The algorithm takes as input two SWAs: [symbol] ₁ and [symbol] ₂, respectively. In case of N SWAs, the composition procedure is applied recursively. As the very first step, the algorithm builds the cross product of all states in the constituent SWAs [symbol] ₁ and [symbol] ₂ (line 1). Next, the intra-location and inter-location rules from Definition 7 are applied sequentially.

Algorithm 3 The pseudo-code used to compose two SWAs

Input: SWA Q₁, Q₂

| | |
|---|---|
| 1: | Q_{c} ← Q₁ × Q₂ |
| | // Apply Rule Intra-Intra |
| 2: | for all q ϵ Q_{c} do |
| 3: | build_self_transition(q) |
| 4: | end for |
| | // Apply Rule Intra-Inter |
| 5: | for all q₁ ϵ Q_{c} do |
| 6: | (l₁, l₂) ← q₁ |
| 7: | for all q₂ ϵ Q_{c} ∧ q₁ ≠ q₂ do |
| 8: | (l₁′, l₂′) ← q₂ |
| 9: | if l₁ = l₁′ ∧ l₂′ then |
| 10: | build_transition(q₁, q₂) |
| 11: | end if |
| 12: | end for |
| 13: | end for |
| | //Rule Inter-Intra and Rule Intra-Intra are similar to Rule Intra-Inter |

The very first rule that we apply is the intra-location transition rule (Rule Intra-Intra). The application of this rule simply requires one to iterate through each state in the product set [symbol] _{c}, building self-transitions on states. The example of the application of Rule Intra-Intra is shown in FIG. 7D. Given state (t₂, b₄) in the resultant SWA; a self-transition from (t₂, b₄) to (t₂, b₄) is introduced. This transition indicates the simultaneous evolution of the ODEs from individual states t₂ and b₄ from the constituent SWAs [symbol] ₁ and [symbol] ₂, respectively. As seen from FIG. 7D, the continuous variables x and y evolve together according to their individual witness functions from the self-transitions on states t₂ and b₄ in FIG. 7C, provided that the conjunction of the individual guards holds.

Next, the three inter-location rules are applied sequentially. Algorithm 3 only shows the application of Rule Intra-Inter, since other rules can be derived from this rule. The algorithm traverses through each state of the the product set [symbol] _{c}. Upon visiting a state q₁, the state label is first decomposed into its constituent parts (line 6). For the running example, given q₁=(t₂, b₄), line 6, gives l₁=t₂ and l₂=4, respectively. Next, we iterate through all the states in [symbol] _{c} other than state q₁, again decomposing the state label into its constituent location names, l_{1′} and l_{2′}, respectively at line 8. Rule Intra-Inter states that the second SWA [symbol] ₂ makes an inter-location transition. SWA [symbol] ₁ on the other hand is forced to make a transition, such that the destination state after the transition has the same location label as the source transition state. Hence, the algorithm builds transitions from state q₁ to any state q₂ such that the constituent label l₁ of state q₁ and l_{1′} of state q₂ are the same, but l₂ and l_{2′} are different. The result of application of such a rule is shown in FIG. 7C, as transition

$$( {t}_{2} {b}_{4} , \frac{\overline{ON} \overline{OFF} ( 0 \leq x [ k ] \leq 100 ) ( y = \frac{1}{10} )}{y [ k + 1 ] = y [ k ] , x [ 0 ] = x [ k ] , OFF , k = 0} , {t}_{2} {b}_{1} ) .$$

The second SWA [symbol] ₂ takes a discrete transition, forcing the first one to also take a discrete transition. This transition is only to a state where the location of the first SWA ( [symbol] ₂) does not change. The guards on this transition are a conjunction of the set of individual guards. We add a special update x[0]=x[k], which carries the value of the continuous variable x. Note that the update x[0]=x[k] is the consequence of i_{1′}=v₁ in Rule Intra-Inter.

### 5. Experimental Results

In this section, the efficacy of an embodiment of the system and method is compared with Simulink®. In particular, the performance is compared relative to execution time and code size. For the purposes of this comparison, seven benchmarks presented in Table 2 are used. These benchmarks span across different application domains such as medical, physics, and industrial automation, illustrating the diversity of the proposed approach. In this embodiment, HA is intended to mean IOHA [28]. IOHA enable the modelling of the plant and the controller separately.

As depicted in column one of Table 2, four out of the seven benchmarks are described using a single HA and the remaining three examples are described using more than one HA. The table also presents the number of locations (#L) in each hybrid automata. For example, (2,3) denotes that the Train Gate Control (TG) benchmark is described using a HA with two locations and a second HA with three locations.

TABLE 2
Benchmark descriptions

| Benchmarks | | Domain | #L | Description |
|---|---|---|---|---|
| Single | Thermostat | Physics [42] | 2 | Heats a room to |
| HA | (TS) | | | keep it warm. |
| | Switch Tank | Physics [43] | 2 | A hose adding water |
| | (ST) | | | by switching |
| | | | | between two |
| | | | | leaky tanks. |
| | Heart Cell (HC) | Biology [44] | 4 | Captures the electrical |
| | | | | behaviour of a cardiac |
| | | | | cell. |
| | Train Brake | Industrial | 2 | Maintains a train's speed |
| | control (TB) | automation | | between the upper and |
| | | [45] | | lower limit. |
| Two | Water Heating | Physics [3] | 4, 4 | Models the heating of |
| HAs | system (WH) | | | water (see FIG. 2). |
| | Train Gate | Industrial | 2, 3 | Models the behaviour |
| | control (TG) | automation | | of a gate at a rail |
| | | [46] | | road crossing. |
| | Nuclear Plant | Industrial | 3, 3 | Switches between two |
| | control (NP) | automation | | fuel rods to avoid |
| | | [47] | | a meltdown. |

### 5.1 Experimental Set-Up

Following steps are considered in order to achieve a fair comparison between the embodiment of the emulation system and Simulink®.

Solver: To reflect the synchronous execution model, a discrete solver with a fixed step is used in Simulink®. The Discrete-Time Integrator block is configured to use the Forward Euler method. Other methods such as Backward Euler and Trapezoidal resulted in an “alebraic loop” error and we did not pursue a solution to this.

Step size: For all benchmarks the step size in Simulink is fixed to 0.01 seconds. Also the same step size is used in the emulation system, δ=0.01 seconds.

Time: All benchmarks were simulated in Simulink for 100,000 seconds of simulation time. Based on a step size of 0.01 seconds, in the emulation system this translates to 10 million ticks.

The experiments are executed on an Intel i7-490 processor with 16 GB RAM running the Windows 7 operating system.

### 5.2 Evaluation

For all the benchmarks, the executable for the Simulink models are generated using the in-build C code generator. It automatically generates equivalent C code and compiles it to produce an executable. Similarly, the emulation system generates equivalent C code and generates executable using GCC. The execution time and the code size of the generated executables are reported below.

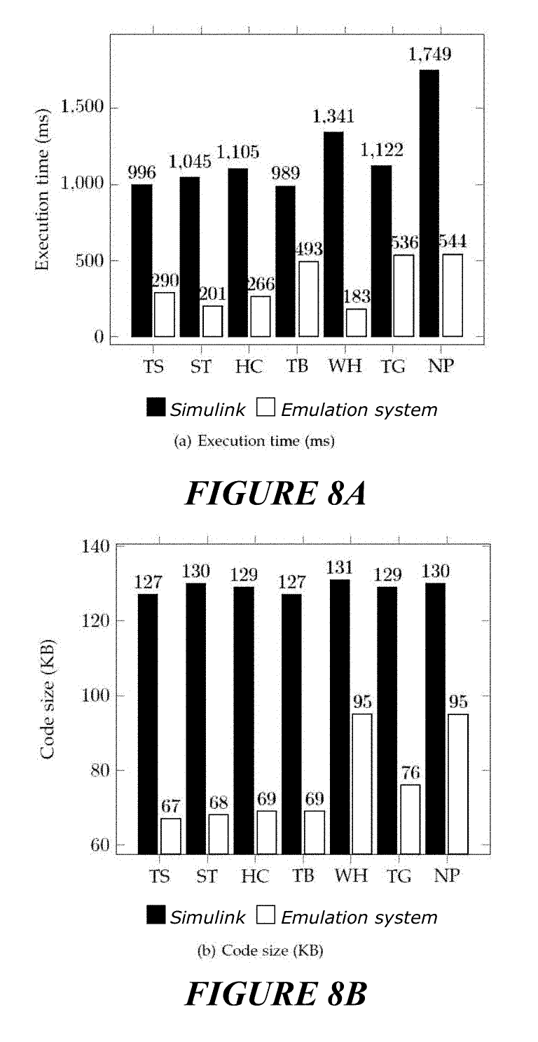

Execution time: FIG. 8A shows that for all benchmarks, the execution times of the emulation system are significantly shorter than Simulink®. On average, the emulation system is 3.9 times faster than Simulink®. The most significant difference between the tools is observed for the most complex example (most locations), the water tank heating system (WH). For this example, the execution time of emulation system is 7.3 times faster than Simulink®.

Code size: FIG. 8B shows that for all benchmarks, the code size of emulation system is significantly smaller than Simulink®. On average, the generated code is 40% smaller than the Simulink® code. The most significant difference is 47% which is observed for the Thermostat example. In general, Simulink® is a more feature rich tool and there may be some overheads during code generation where numerical solvers are linked during compilation.

In summary, on average the emulation system is faster (in execution time) than Simulink® by a factor of 3.9 times and the generated code is 40% smaller than the Simulink code.

Finally, in Table 3, the acceptability of the benchmarks between the emulation system and the tool based on [23] are qualitatively compared. As discussed, earlier in the introduction and Section 4.4, the tool in [23] requires that “a given mode and the corresponding guard of any switch must overlap for a duration that is greater than the sampling period” [23]. Due to this restriction, it is not possible to accept any HA that has a guard condition that checks for equality. For the running example (FIG. 2C), the guard condition x=100 checks if the water has reached the boiling point. Similarly, in the train gate control benchmark, there is a guard condition that checks if the gate height is exactly equal to 10 meters. In summary, due to the saturation function used in the emulation system, the emulation system can accept a larger set of benchmarks for code generation than the tool in [23].

TABLE 3
What benchmarks can be accepted based
on the restrictions of the tool in [23]
and the emulation system

| | Tool | Emulation |
|---|---|---|
| Benchmarks | in [23] | system |
| Thermostat (TS) | Yes | Yes |
| Switch Tank (ST) | Yes | Yes |
| Heart Cell (HC) | Yes | Yes |
| Train Brake control (TB) | Yes | Yes |
| Water Heating system (WH) | No | Yes |
| Train Gate control (TG) | No | Yes |
| Nuclear Plant contorl (NP) | Yes | Yes |

### 6. Summary

Hybrid automata (HA) [4] is a very well known framework for the modelling and verification of CPS [47]. The emulation system and method dislcosed provides for emulation of controllers using plant models that provide real-time closed-loop response, while validating the controllers in a CPS. We term such plant models as plant-on-a-chip (PoC).

HA was initially developed for the simulation/verification of CPS where both the plant and the controller are considered as a single HA. The emulation system and method enables validation of controllers using emulation of the plant. Variants such as input/output HA [28] (IOHA) are proposed to specify both the plant and the adjoining controller and this work has recently been used for the validation of controllers such as pacemakers [27]. The majority of controller validation approaches use tools such as Simulink® for the modelling and code generation of the plant to validate the controller. There are well known semantic limitations of using such tools for validation. Tools such as Ptolemy [13] and Zélus [12], on the other hand, are founded on formal semantics. However, they have limitations for emulating plants due to the dynamic interaction with numerical solvers. There have also been some prior work on automatic code generation from HA models [23, 24]. However, these approaches handle very restrictive set of examples.

The emulation system and method of this disclosure provides emulation of CPS using automated algorithmic techniques for code generation from HA models, such as IOHA models, based on a defined set of one or more well-formedness criteria that are specifically developed for facilitating code generation. The system and method also uses a discrete time semantics of well-formed HA (WHA) based on a synchronous approach. Based on this semantics and an approach for synchronous composition of HA models the system is able to perform modular compilation from a network of HA models to C code for PoC design.

The emulation and method of this disclosure, in at least some embodiments, may provide the following:
A new approach for designing CPS: The overall system design starts with the description of the system as a network of hybrid automata. The system is based on a new semantics of HA based on the notion of Well-formed Hybrid Automata (WHA). The WHA criteria or requirements can be statically checked and those that satisfy the WHA requirements are amenable to code generation. WHA based code generation is less restrictive compared with existing code generators for HA [23], [24] that also avoids dynamic ODE solvers.
Code generation without dynamic numerical solving. The emulation system is configured to implement a synchronous approach for the design of hybrid systems. The synchronous code generator of the emulation system generates code that uses no numerical solver for ODEs at run-time. This is achieved by an algorithm of the emulation system that checks WHA requirements at compile time to create closed form solutions of ODEs using symbolic solvers.
The emulation system and method is configured to provide semantic preserving modular compilation of HAs. The emulation system is based on a compositional semantics such that code can be generated for each HA separately.
The emulation system and method enables a new PoC design approach enabling the emulation of many CPS applications, paving the way for the reduction of the certification effort for safety-critical devices such as pacemakers [27], automotive electronics, and many other applications where certification is a requirement.
The emulation system and method provides for the emulation of a large class of processes based on hybrid automata (HA).
The emulation system and method is configured to perform semantic preserving automatic code generation from a network of hybrid automata descriptions for the purpose of emulation.
The emulation system and method generates code that is devoid of numerical solution to ODEs and hence provides excellent real-time response. The emulation system and method is configured to solve ODEs symbolically and this provides excellent model fidelity as well as real-time response.
The emulation system and method is configured to provide modular code generation from a network of HAs so that complex plant consisting of several components can be emulated. Modular code generation is both efficient and semantic preserving.
The emulation system and method is configured to generate models that preserve the input HA models exactly, unlike Simulink, Zelus or Ptolemy, where the models look very different from input HA. The emulation system and method therefore provides more readable and maintainable code.
The emulation system and method is capable of emulating physical processes in wide-ranging application domains such as medical devices, transportation, robotics, smart power grids, and process control.
The emulation system and method is configured to provide a synchronous approach for the semantic preserving emulation of physical processes.
The emulation system and method generates emulation code that does not use any numerical solver. Rather, it uses symbolic solutions instead. This results in computation that is sound and invariant to the simulation or sample step size during emulation.

### 7. General

Furthermore, embodiments may be implemented by hardware, software, firmware, middleware, microcode, or any combination thereof. When implemented in software, firmware; middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components. Additional elements or components may also be added. Additionally, the features described herein may be implemented in software, hardware, as a business method, and/or combination thereof.

In its various aspects, example embodiments can be embodied in a computer-implemented process, a machine (such as an electronic device, or a general purpose computer suitably programmed or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Modifications may be made thereto without departing from the scope of the invention as defined by the accompanying claims.

### 8. References

[1] E. A. Lee, “Cyber physical systems: Design challenges,” in International Symposium on Object/Component/Service-Oriented Real-Time Distributed Computing (ISORC), May 2008. Invited Paper.

[2] R. Alur, Principles of Cyber-Physical Systems. MIT Press, 2015.

[3] J. -F. Raskin, Handbook of Networked and Embedded Control Systems, ch. An introduction to hybrid automata, pp. 491-517. Springer, 2005.

[4] R. Alur,. C. Courcoubetis, T. A. Henzinger, and P. -H. Ho, “Hybrid automata: An algorithmic approach to the specification and verification of hybrid systems,” in Hybrid Systems, (London, UK, UK), pp. 209-229, Springer-Verlag, 1993.

[5] R. Wilhelm, J. Engblom, A. Ermedahl, N. Holsti, S. Thesing, D. Whalley, G. Bernat, C. Ferdinand, R. Heckmann, T. Mitra, F. Mueller, I. Puaut, P. Puschner, J. Staschulat, and P. Stenström, “The worst-case execution-time problem—overview of methods and survey of tools,” Trans. on Embedded Computing Sys., vol. 7, no. 3, pp. 1-53,2008.

[6] International Electrotechnical Commission, “IEC 61508 Functional safety of electrical/electronic/programmable electronic safety-related systems,” 2010.

[7] International Electrotechnical Commission, “ISO 26262-1: Road vehicles—Functional safety,” 2011.

[8] W. K. Youn, S. B. Hong, K. R. Oh, and O. S. Ahn, “Software certification of safety-critical avionic systems: DO-178C and its impacts,” Aerospace and Electronic Systems Magazine, IEEE, vol. 30, no. 4, pp. 4-13,2015.

[9] “US Food and Drug Administration (FDA).” http://www.fda.gov. last accessed May 29, 2015.

[10] H. Alemzadeh, R. K. Iyer, Z. Kalbarczyk, and J. Raman, “Analysis of safety-critical computer failures in medical devices,” Security & Privacy, IEEE, vol. 11, no. 4, pp. 14-26, 2013.

[11] R. Alur, A. Kanade, S. Ramesh, and K. Shashidhar, “Symbolic analysis for improving simulation coverage of simulink/stateflow models,” in Proceedings of the 8th ACM international conference on Embedded software, pp. 89-98, ACM, 2008.

[12] T. Bourke and M. Pouzet, “Zélus: a synchronous language with ODEs,” in Proceedings of the 16th international conference on Hybrid systems: computation and control, pp. 113-118, ACM, 2013.

[13] C. Ptolemaeus, System Design, Modeling, and Simulation: Using Ptolemy II. Ptolemy. org, 2014.

[14] T. Bourke, J. -L. Cola co, B. Pagano, C. Pasteur, and M. Pouzet, “A Synchronous-based Code Generator For Explicit Hybrid Systems Languages,” in 24th International Conference on Compiler Construction (CC 2015), (London, UK), p. to appear, April 2015.

[15] K. N. Patel and R. H. Javeri, “A survey on emulation testbeds for mobile ad-hoc networks,” Procedia Computer Science, vol. 45, pp. 581-591, 2015.

[16] A. Benveniste, P. Caspi, S. Edwards, N. Halbwachs, P. Le Guernic, and R. de Simone, “The synchronous languages 12 years later,” Proceedings of the IEEE, vol. 91, pp. 64-83, January 2003.

[17] C. Baler and J. -P. Katoen, Principles of Model Checking. The MIT Press, 2008.

[18] G. Frehse, C. Le Guernic, A. Donzé, S. Cotton, R. Ray, O. Lebeltel, R. Ripado, A. Girard, T. Dang, and O. Maler, “SpaceEx: Scalable Verification of Hybrid Systems,” in International Conference on Computer Aided Verification (CAV) (S. Q. Ganesh Gopalakrishnan, ed.), LNCS, Springer, 2011.

[19] S. Tripakis, C. Sofronis, P. Caspi, and A. Curic, “Translating discrete-time Simulink to Lustre,” ACM Transactions on Embedded Computing Systems (TECS), vol. 4, no. 4, pp. 779-818, 2005.

[20] S. Andalam, P. S. Roop, A. Girault, and C. Traulsen, “A predictable framework for safety-critical embedded systems,” IEEE Transactions on Computers, vol. 63, no. 7, pp. 1600-1612, 2014.

[21] “SCADE Tools.” http://www.esterel-technologies.com/.last accessed—19.6.15.

[22] X. Fornari, “Understanding how SCADE suite KCG generates safe C code,” White paper, Esterel Technologies, 2010.

[23] R. Alur, F. Ivancic, J. Kim, I. Lee, and O. Sokolsky, “Generating embedded software from hierarchical hybrid models,” ACM SIGPLAN Notices, vol. 38, no. 7, pp. 171-182, 2003.

[24] J. Kim and I. Lee, “Modular code generation from hybrid automata based on data dependency,” in Real-Time and Embedded Technology and Applications Symposium, 2003. Proceedings. The 9th IEEE, pp. 160-168, IEEE, 2003.

[25] D. Bresolin, L. Di Guglielmo, L. Geretti, and T. Villa, “Correct-by-construction code generation from hybrid automata specification,” in International Wireless Communications and Mobile Computing Conference (IWCMC), pp. 1660-1665, July 2011.

[26] L. H. Yoong, P. S. Roop, Z. E. Bhatti, and M. M. Kuo, Model-Driven Design Using IEC 61499. Springer, 2015.

[27] T. Chen, M. Diciolla, M. Kwiatkowska, and A. Mereacre, “Quantitative verification of implantable cardiac pacemakers over hybrid heart models,” Information and Computation, vol. 236, pp. 87-101, 2014.

[28] N. Lynch, R. Segala, and F. Vaandrager, “Hybrid I/O automata,” Information and computation, vol. 185, no. 1, pp. 105-157, 2003.

[29] C. Brooks, E. A. Lee, D. Lorenzetti, T. Nouidui, and M. Wetter., “Demo: Cyphysim—a cyber-physical systems simulator,” in 18th International Conference on Hybrid Systems: Computation and Control (HSCC 2015), 2015. Presented as a demo at HSCC 2015, Seattle.

[30] R. Alur and D. L. Dill, “A theory of timed automata,” Theoretical computer science, vol. 126, no. 2, pp. 183-235, 1994.

[31] D. Harel and A. Pnueli, “On the Development of Reactive Systems,” in Logics and Models of Concurrent Systems (K. Apt, ed.), NATO ASI Series, Vol. F-13, (La Colle-sur-Loup, France), pp. 477-498, Springer-Verlag, 1985.

[32] K. Ogata, Modern control engineering. Boston: Prentice-Hall, 2010.

[33] H. Carlsson, B. Svensson, F. Danielsson, and B. Lennartson, “Methods for reliable simulation-based PLC code verification,” Industrial Informatics, IEEE Transactions on, vol. 8, no. 2, pp. 267-278,2012.

[34] L. Ju, B. K. Huynh, A. Roychoudhury, and S. Chakraborty, “Performance Debugging of Esterel Specifications,” in IEEE/ACM/IFIP International Conference on Hardware/Software Codesign and System Synthesis (CODES+ISSS), (Atlanta), pp. 173-178, ACM, October 2008.

[35] P. S. Roop, S. Andalam, R. von Hanxleden, S. Yuan, and C. Traulsen, “Tight WCRT Analysis of Synchronous C Programs,” in Proceedings of the international conference on Compilers, architecture, and synthesis for embedded systems (CASES), (Grenoble), pp. 205-214, ACM, October 2009.

[36] J. J. Wang, P. S. Roop, and S. Andalam, “ILPc: A Novel Approach for Scalable Timing Analysis of Synchronous Programs,” in International Conference on Compilers, Architecture, and Synthesis for Embedded Systems (CASES), October. 2013.

[37] G. Berry, “The foundations of Esterel.,” in Proof, language, and interaction, pp. 425-454, 2000.

[38] N. Halbwachs, P. Caspi, P. Raymond, and D. Pilaud, “The synchronous data flow programming language lustre,” Proceedings of the IEEE, vol. 79, no. 9, pp. 1305-1320, 1991.

[39] P. LeGuernic, T. Gautier, M. Le Borgne, and C. Le Maire, “Programming real-time applications with SIGNAL,” Proceedings of the IEEE, vol. 79, no. 9, pp. 1321-1336, 1991.

[40] W. Rudin, Real and complex analysis. Tata McGraw-Hill Education, 1987.

[42] H. Joao Pedro, “How to describe a hybrid system? Formal models for hybrid system.” University of California at Santa Barbara, Course ECE229, Lecture 2. http://www.ece.ucsb.edu/^{˜}hespanha/ece229/Lectures/Lecture2.pdf, 2005.

[43] J. Lygeros, C. Tomlin, and S. Sastry, “Hybrid systems: Modeling, analysis and control.” University of California, Berkeley, Course EE291e. http://inst.cs.berkeley.edu/^{˜}ee291e/sp09/handouts/book.pdf, 2009.

[44] T. Chen, M. Diciolla, M. Kwiatkowska, and A. Mereacre”, “Quantitative verification of implantable cardiac pacemakers over hybrid heart models,” Information and Computation, vol. 236, pp. 87-101, 2014.

[45] A. Platzer, “Logical analysis of hybrid systems,” in Descriptional Complexity of Formal Systems, pp. 43-49, Springer, 2012.

[46] C. Brennon and E. Joshua, “Hybrid Systems.” Tufts University, Course EE194, Lecture. http://www.eecs.tufts.edu/^{˜}khan/Courses/Spring2013/EE194/Lecs/Hybrid Systems Presentation Elliott Costello.pdf, 2013.

[47] R. Alur, Principles of Cyber-Physical Systems. MIT press, April 2015.

1. A method of generating code for deploying on a target emulation platform for the emulation of at least an aspect of a hybrid system, the method executed on a processor having associated memory, and comprising:
receiving, retrieving or generating input hybrid automata (HA) data indicative of one or more hybrid automata models representing at least an aspect of the hybrid system;
processing the input hybrid automata (HA) data to statically determine whether each hybrid automata model satisfies one or more predefined well-formedness criteria to qualify as well-formed hybrid automata (WHA) models, the well-formedness criteria at least requiring that any ordinary differential equations (ODEs) defining each hybrid automata model be closed-form in nature such that they are analytically or symbolically solvable;
transforming the well-formed hybrid automata (WHA) models into corresponding respective synchronous hybrid automata (SHA) models, where the synchronous hybrid automata models are an under-approximation of their well-formed hybrid automata (WHA) where any ordinary differential equations are replaced with their corresponding witness function representing the closed-form solution of the ordinary differential equation; and
generating emulation code for deployment onto a target emulation platform based on the synchronous hybrid automata (SHA) models so an aspect or aspects of the hybrid system can be emulated on the target emulation platform in a semantic preserving manner.

2. A method according to claim 1 wherein the input hybrid automata data corresponds to any one of the following: one or more hybrid automata models representing an aspect or aspects of a physical process or plant of the hybrid system; and/or one or more hybrid automata models representing an aspect or aspects of the controller and the physical process and/or plant of the hybrid system; and/or a network of hybrid automata models representing an aspect of the controller and/or physical process and/or plant and/or hybrid input/output automata models representing an aspect or aspects of the physical process or plant of the hybrid system.

3. (canceled)

4. (canceled)

5. (canceled)

6. A method according to claim 1 wherein the well-formedness criteria further requires that all solutions (witness functions) to the ordinary differential equations (ODEs) are monotonic.

7. A method according to claim 6 wherein the well-formedness criteria define witness functions of ordinary differential equations (ODEs) to be monotonic if the first derivative of the witness function does not change sign.

8. A method according to claim 1 wherein the well-formedness criteria further requires that all invariants, jump and initial predicates are constrained or bounded by natural or rational numbers.

9. A method according to claim 1 wherein processing each hybrid automata model to determine if the ODEs are closed-form in nature comprises sequentially processing the ODEs at each location in the hybrid automata model to determine whether each is analytically or symbolically solvable.

10. A method according to claim 1 further comprising generating an error signal or message if any of the hybrid automata models represented by the input hybrid automata do not satisfy the well-formedness criteria.

11. A method according to claim 1 wherein the synchronous hybrid automata (SHA) models represent an under-approximation of their corresponding well-formed hybrid automata (WHA) models in that the valuation of continuous variables in the SHA models is made at discrete valuation instants and the values of the continuous variables remain constant between two adjacent distinct valuation instants.

12. A method according to claim 1 wherein generating emulation code for deployment onto a target emulation platform based on the synchronous hybrid automata (SHA) models comprises transforming each SHA model into a corresponding respective synchronous witness automata (SWA) that represents the behavior of the SHA model as a synchronous state machine, and generating the emulation code based on the individual SWA models.

13. A method according to claim 12 wherein generating the emulation code based on the individual SWA models comprises linking the of the SWA modules by parallel composition of the SWA models into a single SWA model from which the emulation code is derived.

14. A method according to claim 13 wherein the parallel composition is applied recursively.

15. A method according to claim 12 wherein generating the emulation code based on the individual SWA models comprises generating modular code representing each respective SWA model and linking the modular code to generate the emulation code.

16. A method according to claim 1 wherein transforming the well-formed hybrid automata (WHA) models into corresponding respective synchronous hybrid automata (SHA) models comprises generating each SHA such that it executes in code as a Discrete Time Transition System (DTTS) such that all transitions trigger relative to the ticks of a logical clock associated with the generated code.

17. A method according to claim 1 further comprising configuring the emulation code to dynamically saturate continuous variables to a saturation value when switching states or locations if the continuous variable does not satisfy a guard condition.

18. A method according to claim 1 wherein the emulation code is C code, or wherein the emulation code is in the form of a hardware description language or wherein the emulation code is in the form of VHDL code, or wherein the emulation code is in the form of data indicative of a finite state machine.

19. (canceled)

20. (canceled)

21. (canceled)

22. A method according to claim 1 further comprising converting or compiling the emulation code into an executable or binary file for deploying and executing on the target emulation platform.

23. A method according to claim 1 wherein the target emulation platform comprises any one or more of the following: a processor, FPGA, or ASIC.

24. A method of generating code for deploying on a target emulation platform for the emulation of at least an aspect of a hybrid system, the method executed on a processor having associated memory, comprising generating emulation code representing an aspect or aspects of the hybrid system based only on input hybrid automata that are verified as being analytically or symbolically solvable.

25. A method of generating code for deploying on a target emulation platform for the emulation of at least an aspect of a hybrid system, the method executed on a processor having associated memory, comprising:
receiving, retrieving or generating input hybrid automata (HA) data indicative of one or more hybrid automata models representing at least an aspect of the hybrid system;
verifying if the hybrid automata models are well-formed;
generating modular code representing each verified well-formed hybrid automata model;
linking the modular code to generate emulation code representing the aspect or aspects of the hybrid system for execution on a target emulation platform.

26. A code generation system for generating emulation code for deploying on a target emulation platform for the emulation of at least an aspect of a hybrid system comprising:
an input interface that is operable or configured to receive, retrieve or generate input hybrid automata (HA) data indicative of one or more hybrid automata models representing at least an aspect of the hybrid system;
a processor configured to carry out the methods of claim 1; and
an output interface for outputting the generated emulation code.

27. An emulation system for testing or validating a controller of a hybrid system comprising:
a controller;
an emulation platform operatively connected to or in data communication with the controller, the emulation platform executing emulation code generated by the method of claim 1 that represents an aspect or aspects of the hybrid system.

28. An emulation system according to claim 27 wherein the emulation code represents a physical process or plant of the hybrid system.

29. (canceled)

30. (canceled)

31. (canceled)
